(19) United States
(12) Patent Application Publication
(10) Pub. No.: US 2009/0177487 A1
(43) Pub. Date: Jul. 9, 2009

(54) Methods for Assessing Genetic Compatibility

(76) Inventor: Tera Eerkes, Bainbridge Island, WA (US)

Correspondence Address: K&L Gates LLP, STATE STREET FINANCIAL CENTER, One Lincoln Street, BOSTON, MA, 02111-2950, US

(21) Appl. No.: 12/349,894

(22) Filed: Jan. 7, 2009

Related U.S. Application Data
(60) Provisional application No. 61/010,267, filed on Jan. 7, 2008.

(51) Int. Cl. G06Q 50/00; G06F 17/30; G06Q 99/00; G06N 5/02

(52) U.S. Cl. 705/1; 707/104.1; 706/46

(57) ABSTRACT

The invention relates to a method of constructing a compatibility profile for an individual based on a data set including alleles corresponding to four or more human leukocyte antigen (HLA) loci and optionally the AVPR1A locus and assigning an encoded reference to each allele in the data set. The invention further relates to methods for evaluating the compatibility of two individuals for sexual satisfaction and/or long term relationship potential based on their compatibility profiles.

### CROSS REFERENCE TO RELATED APPLICATIONS

This application claims the benefit under 35 U.S.C. 119(e) of U.S. Provisional Patent Application Ser. No. 61/010,267, filed Jan. 7, 2008, the entire disclosure of which is incorporated by reference herein.

### FIELD OF THE INVENTION

The invention relates to methods for using a genetic and/or biomarker compatibility profile of an individual to evaluate the compatibility of the individual with a second individual having a second compatibility profile to identify the best possible sexual partners or long term relationship partners. The invention further relates to methods of using a compatibility profile in a dating service, social networking service, or other interactive service.

### BACKGROUND OF THE INVENTION

According to recent scientific literature and independent research, two individuals who share an optimal number of human leukocyte antigen (HLA) alleles have compatibility and partnering advantages. Alleles are a variant of the nucleotide (DNA) sequence at a locus, such that each allele differs from all other alleles in at least one nucleotide position. In the case where the allele differs in one nucleotide position, the change is referred to as a single nucleotide polymorphism, or SNP. Many of these changes result in a change in the amino acid sequence that results in slight to major functional differences in the resulting protein.

HLA alleles reside on human chromosome 6 and encode proteins expressed on the exterior surface of body cells to identify the cell as a “self” cell, therefore not an invader “non-self” cell targeted for immune system destruction. The major HLA antigens include class I antigens (HLA-A, HLA-B and HLA-C) and class II antigens (HLA-DR, HLA-DP and HLA-DQ). The minor HLA antigens include additional class I antigens (HLA-E, HLA-F and HLA-G) and class II antigens (HLA-DM and HLA-DO).

HLA genetic loci are some of the most genetically variable coding loci in mammals. Most of the loci include at least a dozen or more allele-groups at each locus and continue to evolve. Five loci have over 100 alleles, of these the most variable are HLA-B and HLA-DRB1.

AVPR1A alleles reside on human chromosome 12 and encode one of the brain neuropeptide arginine vasopressin (AVP) receptor subtypes (V1aR). A strong association has been found between a polymorphic repeat sequence in the 5′ flanking region of the AVPR1A gene and proneness for monogamous behavior in male voles and in male humans, including partner bonding, perceived marital problems, and marital status, as well as marital quality as perceived by their spouses. In particular, the presence of the RS3 334 allele in males has been correlated with a decreased rate of monogamy and marriage. Homozygous males with two copies of the RS3 334 allele are significantly less likely to be monogamous or married.

Accordingly, Applicants' claimed invention provides a method for identifying a compatibility profile including, for example, HLA data and/or AVPR1A data, and assessing the sexual and/or long term relationship compatibility of two individuals according to the similarity or dissimilarity of their compatibility profiles. Applicants' claimed invention further provides a method for offering services, for example, compatibility matching or dating services, and for offering compatibility widgets, for example, for display or use of a compatibility profile on a social networking or other computer implemented software application or online service.

### SUMMARY OF THE INVENTION

In one aspect, the invention relates to a method of constructing a compatibility profile for an individual. The method includes the steps of providing a data set for the individual, the data set having alleles corresponding to four or more human leukocyte antigen (HLA) loci, and providing a computer programmed with a comparison software application to assign a secure reference number to each allele in the data set. According to one embodiment, the data set further includes alleles corresponding to the AVPR1A locus.

In another aspect, the invention relates to a method of evaluating the compatibility of a first individual and a second individual. The method includes the steps of providing a first data set for a first individual and a second data set for a second individual, each of the first and second data sets having alleles for at least four human leukocyte antigen (HLA) loci, calculating a number of similar HLA alleles between an alignment of the first and second data sets, assigning a compatibility score corresponding to the number of similar HLA alleles between the first individual and the second individual and displaying the compatibility score and/or a compatibility recommendation on a computer user interface.

According to various embodiments of the method, the method can further include the step of assigning a secure reference number to each allele in the data set. The data set can further include alleles corresponding to the AVPR1A locus. According to various embodiments, the presence of two alleles corresponding to a high-risk AVPR1A locus correlates with a high risk for non-monogamous behavior and decreased likelihood of marriage, the presence of one allele corresponding to a high-risk AVPR1A locus correlates with a moderate risk for non-monogamous behavior and decreased likelihood of marriage, and the presence of no copies of an allele corresponding to a high-risk AVPR1A locus correlates with a low risk for non-monogamous behavior and reasonable or average likelihood of marriage.

The data set can include the alleles identified through an analysis of at least 493 single nucleotide polymorphisms (SNPs). The method can further include the step of reporting to the first individual a compatibility recommendation corresponding to the compatibility score. In various embodiments, a compatibility score of 0 results in a compatibility recommendation of optimal for sexual satisfaction and/or adequate for long term relationship potential, a compatibility score of 1 results in a compatibility recommendation of reasonable for sexual satisfaction and/or reasonable for long term relationship potential, a compatibility score of 2 or 3 results in a compatibility recommendation of adequate for sexual satisfaction and/or optimal for long term relationship potential, and a compatibility score of 4 or more results in a compatibility recommendation of poor for sexual satisfaction and/or undetermined for long term relationship potential.

In another aspect, the invention relates to a method of operating a dating service. The method includes the steps of providing a computer programmed with a comparison software application to calculate a compatibility score of a first individual and a second individual according to the method described above, and communicating a compatibility recommendation based on the compatibility score.

In various embodiments of this method, the dating service can be offered through a website, can be offered as a widget on a website, and can further include calculating a compatibility score of the first individual and each member of a group of individuals where the group of individuals are friends, clients or subscribers.

In another aspect, the invention relates to a method of conducting business. The method includes the steps of providing a collection kit to a customer, receiving the collection kit and a sample from the customer, evaluating the sample for the presence of at least one single nucleotide polymorphism (SNP) associated with at least one human leukocyte antigen (HLA) allele, assigning a secure reference number to the at least one HLA allele to construct a compatibility profile, communicating the compatibility profile to the customer in a computer-readable format adapted for display on a website user interface, and comparing the compatibility profile of the customer to a compatibility profile of a second customer and communicating a compatibility recommendation to at least the customer. According to one embodiment, the customer initiates the comparison. According to another embodiment, the method further includes evaluating the sample for the presence of at least one AVPR1A allele and assigning an encoded reference to the AVPR1A allele to construct the compatibility profile.

In a further aspect, the invention relates to a system for comparing the compatibility profiles of at least two individuals. According to one embodiment, the system can be a comparison software application programmed on a computer or accessed on a website user interface.

### BRIEF DESCRIPTION OF THE DRAWINGS

Table I is an index of 493 single nucleotide polymorphisms (SNPs) associated with various human leukocyte antigen (HLA) alleles.

Table II is an index of 2694 probes associated with various human leukocyte antigen (HLA) alleles.

### DETAILED DESCRIPTION OF THE INVENTION

The invention provides a method for assessing the compatibility of two or more individuals according to each individual's compatibility profile. According to various embodiments, the compatibility profile includes one or more of the following profiles: human leukocyte antigen (HLA) profile, AVPR1A profile, other gene profiles, other biomarker profiles, and/or other personal characteristics potentially indicative of compatibility.

According to one embodiment, the method includes one or more than one of the following steps: determining the HLA alleles of an individual, encoding the HLA alleles into an HLA profile, providing the encoded HLA profile to the individual, comparing the HLA profile of the first individual to an HLA profile of a second individual, and reporting the compatibility of the two individuals based on the level of similarity or dissimilarity of their HLA profiles.

According to another embodiment, the method includes one or more than one of the following steps: determining the AVPR1A alleles of an individual, encoding the AVPR1A alleles into an AVPR1A profile, providing the encoded AVPR1A profile to the individual, comparing the AVPR1A profile of the first individual to an AVPR1A profile of a second individual, and reporting the compatibility of the two individuals based on the level of similarity or dissimilarity of their AVPR1A profiles.

According to a further embodiment, the method includes one or more than one of the following steps: determining the HLA alleles and the AVPR1A alleles of an individual, encoding the HLA alleles and the AVPR1A alleles into an HLA and AVPR1A profile, providing the encoded HLA and AVPR1A profile to the individual, comparing the HLA and AVPR1A profile of the first individual to an HLA and AVPR1A profile of a second individual, and reporting the compatibility of the two individuals based on the level of similarity or dissimilarity of their HLA and AVPR1A profiles.

According to additional embodiments, the method includes the use of a compatibility profile, for example, an HLA profile, an AVPR1A profile, or an HLA and AVPR1A profile, in a dating service, a social networking service, or other recreational service. According to various embodiments, the encoding, comparing, providing and/or reporting steps can be performed using a comparison software application programmed on a computer or other electronic device, including but not limited to a mobile telephone or other mobile computing device, or accessed on a website user interface.

Determining HLA and/or AVPR1A alleles. According to various embodiments, the HLA and/or AVPR1A alleles of an individual can be determining using antibody-based serotyping, gene sequencing to detect single nucleotide polymorphisms (SNPs), genotyping or other allelic detection method(s) now known or later developed by one of skill in the field.

According to one method of determining the HLA alleles of an individual, an antibody-based serotyping method is used. According to this method, blood from the individual is collected, the blood cells are allowed to separate from the sera, and the sera is diluted to its optimal sensitivity and used to type cells from other individuals. Serotyping is used to identify HLA receptors and receptor isoforms. Several types of serotyping can be used according to the method of the invention, including but not limited to broad antigen serotyping.

According to an additional method of determining the HLA or AVPR1A alleles of an individual, an HLA or AVPR1A gene sequencing method is used. According to this method, saliva or blood from the individual is collected. Gene sequencing is conducted and the resulting identified single nucleotide polymorphisms (SNPs) are used to identify known alleles. According to one embodiment, the sample is evaluated for the presence of at least 320 SNPs; more preferably at least 363 SNPs, and most preferably at least 493 SNPs. According to one embodiment, the sample is evaluated for the presence of one or more of the SNPs identified in Table I. According to another embodiment, the sample is evaluated using sequence specific primers or probes, for example, the probes set forth in Table II, to amplify specific portions of HLA alleles to identify each HLA locus at a degree of precision of at least two digits (e.g., HLA*B27), at least three digits, at least four digits (e.g., HLA*B2701), at least five digits, at least six digits, at least seven digits, or at least eight digits (e.g., HLA*B27010101) precision.

According to a further method of determining the HLA or AVPR1A alleles of an individual, an HLA or AVPR1A genotype is used. According to this method, saliva or blood from the individual is collected. Using sequence specific amplification, sequence specific primers are designed to map to one and only one allele of each SNP and labeled fluorescently to distinguish each allele. The fluorescence of the PCR product is measured according to a fluorescence detection and/or measurement method known in the art. The allele is determined to be either all one type of allele, all the other type of allele, or a mixture of both possible alleles. According to another embodiment, the sample is evaluated using sequence specific primers or probes, for example, the probes set forth in Table II, to amplify specific portions of HLA alleles to identify each HLA locus at a degree of precision of at least two digits (e.g., HLA*B27), at least three digits, at least four digits (e.g., HLA*B2701), at least five digits, at least six digits, at least seven digits, or at least eight digits (e.g., HLA*B27010101) precision.

According to one embodiment, at least four of the following HLA loci are interrogated to determine the HLA alleles of an individual: HLA-A, HLA-B, HLA-C, HLA-E, HLA-F, HLA-G, HLA-DQ, HLA-DR, HLA-DP, HLA-DM and HLA-DO. According to a most preferred embodiment, at least the following four HLA loci are interrogated to determine the HLA alleles of an individual: HLA-A, HLA-B, HLA-C and HLA-DQ. According to another preferred embodiment, in addition to HLA-A, HLA-B, HLA-C and HLA-DQ, one or more of the following additional HLA loci are also interrogated to determine the HLA alleles of an individual: HLA-E, HLA-F, HLA-G, HLA-DR, HLA-DP, HLA-DM and HLA-DO.

Encoding an HLA and/or AVPR1A profile. According to one method of encoding the HLA and/or AVPR1A alleles into an encoded HLA and/or AVPR1A profile, the allele at each locus is assigned an encoding reference. Examples of encoding reference include, but are not limited to, numbers, icons, signs, figures, graphics, images, symbols, designators, words, phrase, word handles, sounds, or other visual, auditory or tactile designations. According to one embodiment, each allele is randomly assigned one of 5000 encoding references using a random encoding reference generating algorithm without replacement to ensure that each encoding reference is used only once. Because each individual has two alleles (one maternal and one paternal) at each HLA loci and at the AVPR1A locus, the HLA and/or AVPR1A profile can include information about one or both alleles for any HLA and/or AVPR1A loci.

According to one exemplary embodiment, an individual with the alleles HLA-A*0102 and HLA-A*0103, HLA-B*5101 and HLA-B*1301, HLA-C*1203 and HLA-C*0704, and HLA-DQ*0704 and HLA-DQ*0402, results in the following two strings of encoded references corresponding to the encoded HLA profile 14.2.5.4 and 1.11.9.4, in an exemplary embodiment wherein the encoded references are numbers, or Tiger.Wave.Diatom.Raven and Moon.Star.Stone.Raven, in an alternative exemplary embodiment wherein the encoded references are words or symbols. According to this exemplary HLA profile, the individual has two copies of the same allele at a locus (in this example, HLA-DQ), resulting in both strings of encoded references in the encoded HLA profile having the same encoded reference, in this exemplary embodiment, the same number (4) or word (Raven), at that position.

According to another exemplary embodiment, an AVPR1A profile can be encoded based on the presence and number of copies of one or more particular AVPR1A alleles, for example, the RS3 334 allele. An individual having two copies of the RS3 334 allele is encoded as having the highest risk of non-monogamous behavior, such as extra-partner relationships, and decreased likelihood of marriage. An individual having one copy of the allele is encoded as having moderate increased risk for non-monogamous behavior and decreased likelihood of marriage. An individual having no copies of the allele is encoded as having the lowest risk of non-monogamous behavior and reasonable likelihood of marriage.

According to various embodiments, the encoding step can be performed using a comparison software application programmed on a computer or accessed on a website user interface.

Providing the encoded HLA and/or AVPR1A profile. According to one method of the invention, the encoded HLA and/or AVPR1A profile is provided to the individual, for example, in the form of two strings of encoded references corresponding to the encoded HLA and/or AVPR1A profile. According to one embodiment, the encoded HLA and/or AVPR1A profile is provided to the individual in the form of a software-based widget displaying or containing the encoded HLA and/or AVPR1A profile for use with a social networking software application or user interface environment. According to alternative embodiments, the encoded HLA and/or AVPR1A profile can be displayed, for example, as a badge, a tattoo, a graphic, or a widget. Additionally, the encoded HLA and/or AVPR1A profile can be displayed on a variety of forms of media, including, but not limited to, print, electronic including websites, blogs, widgets and cellular phones, t-shirts, skin including temporary tattoos, and advertisements including newspaper and electronic personal advertisements.

According to one exemplary embodiment, an encoded HLA and/or AVPR1A profile is provided to the individual. The individual can then display the encoded profile, for example, as a badge or widget, on the media of their choosing, for example, on their blog, their FaceBook page, their MySpace page, their Twitter page, a software application on their cellular phone, or other electronic media platforms and applications accessible to potentially compatible second individuals. According to various embodiments, the providing and/or displaying steps can be performed using a comparison software application programmed on a computer or accessed on a website user interface.

According to an additional exemplary embodiment, an encoded HLA and/or AVPR1A profile is provided to the individual and the individual can display the encoded profile on a tangible graphic media, for example, a t-shirt, a piece of jewelry, or a temporary tattoo.

Evaluating HLA and/or AVPR1A compatibility. According to one method of the invention, the encoded HLA and/or AVPR1A profile of a first individual is compared to the encoded HLA and/or AVPR1A profile of a second individual. According to this method, the encoded HLA and/or AVPR1A profile of a first individual, comprised of one or two strings of encoded references, is compared to the encoded HLA and/or AVPR1A profile of a second individual. According to various embodiments, the comparing step can be performed using a comparison software application programmed on a computer or accessed on a website user interface.

According to various embodiments, the number of HLA and/or AVPR1A loci evaluated and the number of similar or dissimilar alleles at an HLA and/or AVPR1A loci are used to determine whether the two individuals are a poor match, a reasonable match, an adequate match or an optimal match are modified.

According to a currently preferred embodiment, if the two individuals have identical HLA profiles, they are a poor match in both sexual satisfaction and in long term relationship potential. If the two individuals share alleles at two or three HLA loci, they are an adequate match for sexual satisfaction and an optimal match for long term relationship potential. If the two individuals share alleles at one HLA locus, they are a reasonable match for sexual satisfaction and a reasonable match for long term relationship potential. If the two individuals share no HLA alleles, they are an optimal match for sexual satisfaction and an adequate match for long term relationship potential.

According to another currently preferred embodiment, if the two individuals have requested attributes that are concordant with the other's AVPR1A profile, they are an optimal match for dating and social partnership. For example, if both individuals have two copies of the high-risk AVPR1A allele, such that they are each prone to similar outcomes in monogamous relationship potential, or similar requested attributes, such that they are each seeking a match having a similar interest in monogamous relationship potential, they are an optimal match. If, in contrast, the individuals have AVPR1A alleles that contrast with the other individual's requested attributes relating to monogamous relationship potential, they are a poor match.

According to one embodiment, the invention relates to a computer encoded with a comparison software application or other machine-based comparison application or to a user interface hosting a comparison software application on a website for comparing encoding profiles or for calculating a compatibility score between two or more individuals. According to one embodiment, individuals can use the software application to calculate a compatibility score. Individuals can compare the number of similar or dissimilar encoded references between two or more individuals to identify poor, reasonable, adequate, or optimal matches for sexual satisfaction and/or long term relationship potential, for example, using a computer software application or other machine-based comparison application or by conducting a visual comparison.

According to one embodiment, the comparison application is integrated into an electronic media platform to allow the individual to select and compare their encoded profile to the encoded profile of a second individual on the platform to determine their potential compatibility. According to an additional embodiment, the comparison application can allow the first individual to search for second individuals on the platform that have optimal or adequate potential compatibility. The second individuals can be selected from a specific group of individuals, for example, a group located in a geographic region, for example, within the same geographic region as the first individual, a group having a common affiliation, for example, belonging to the same school or religious organization as the first individual, or a group having a personal affiliation, for example, being a friend or a friend of a friend of the first individual.

According to another embodiment, the invention relates to a software application including a search engine capable of searching the internet for individuals displaying encoding profiles. Additionally, upon identification of an encoded profile, the software application can compare the encoded profile of the first individual to the encoded profile of the second individual to determine whether the two individuals are potentially compatible. Furthermore, the software application can rank some or all of the compared second individuals to identify those second individuals who are identified as optimal or adequate matches for sexual satisfaction and/or long term relationship potential.

According to a further embodiment, the invention relates to a software application capable of identifying local or proximate second individuals who, based on their encoded profiles, are potentially compatible. For example, the software application can be loaded onto a cellular phone and can identify second individuals within a geographic range, for example, within range of the same cellular receiver or within a restaurant or bar. If a second individual having an encoded profile is located, the software application will compare the encoded profiles of the first individual and the second individual.

According to one embodiment, the software application automatically compares the encoded profile of every second individual within range. According to another embodiment, the software application identifies a second individual within range and requests the first individual to manually initiate the comparison. According to one embodiment, the result of the comparison is communicated to the first and/or second individual or, alternatively, the result of the comparison is communicated if the comparison results in a potential optimal or adequate match.

According to one embodiment, the software application can communicate the results of the comparison to the first and/or second individual and, optionally, initiate single blind or double blind contact between the potentially compatible first and second individuals. According to one exemplary use, a first individual is located in a bar and has a cellular phone containing an encoded profile comparison software application. If the software application detects a second individual within the bar having an encoded profile, for example, an encoded profile resulting in an optimal or adequate match with the first individual, the software application will offer the first individual the option of initiating contact with the second individual, for example, through text messaging or other communication method. According to one embodiment, the contact is double blind, such that neither the first individual nor the second individual are presented with identifying information for the other individual until they agree to meet, for example, by choosing a time and location for meeting. According to another embodiment, the contact is single blind, such that the first individual may provide their personal information, for example, a picture or profile, to the second individual, but the second individual's personal information will not be shared with the first individual until the second individual agrees to release their personal information. According to a further embodiment, the contact is transparent or, optionally, transparent provided the first and second individuals have agreed in advance to release their personal information to all or to a select subgroup of second individuals.

According to various additional embodiments, the encoded profile can contain additional characteristics indicative of potential compatibility. Additional characteristics include, but are not limited to, gender, sexual orientation, relationship status, and whether the individual seeks mates for sexual satisfaction and/or for a long term relationship. These additional characteristics can be compared, alone or in addition to the encoded HLA and/or AVPR1A profile, to determine potential compatibility.

Reporting compatibility. According to one method of the invention, the result of the HLA and/or AVPR1A profile comparison between a first individual and a second individual is reported to one or both of the individuals. According to one embodiment, the result is communicated as an optimal match, an adequate match, a reasonable match, or a poor match. According to another embodiment, the result is communicated only if the comparison results in an optimal match or an adequate match. According to a further embodiment, the result is communicated as a ranking of a comparison between a first individual and a group of second individuals, for example, ranking the compared second individuals based on whether they are an optimal match, an adequate match, a reasonable match, or a poor match. According to various embodiments, the reporting step can be performed using a comparison software application programmed on a computer or accessed on a website user interface.

Methods of using the compatibility profile. According to one method, the comparison is performed as a dating service or as part of a dating service. According to this method, the compatibility profile, for example, HLA profile and/or AVPR1A profile, of a first individual is compared against a library or database of compatibility profiles of other individuals. According to this method, individuals identified as optimal matches, and, optionally, individuals identified as adequate matches according to the compatibility evaluation method discussed above, are presented for consideration and/or introduction to the first individual.

According to one method wherein the comparison is performed as a dating service, the service is provided for free and no fee is charged to either the first individual or any second individual. According to another embodiment, the first individual is charged a first fee for determination and/or encoding of a compatibility profile. According to various further methods, for free, as part of the first fee paid by the first individual, or for an additional fee, the first individual receives a limited membership in the dating service, such that the first individual may conduct comparisons, identify optimal or reasonable matches, and/or communicate with matches for a specified duration of time. According to various methods, the specified duration of time for the limited membership consists of a one month, two month, three month, six month, one year, two year or other period of time. According to another method, the first individual is charged a second fee for the limited membership. According to a further method, the first individual is charged a subscription fee, renewable for one or more than one subsequent limited memberships or durations of time. According to this method, the first individual is a subscriber.

According to another embodiment, the service is provided for free and no fee is charged to either the first individual or any second individual. According to another embodiment, the first individual is charged a first fee for determination and/or encoding of a compatibility profile. According to various further embodiments, for free, as part of the first fee paid by the first individual, or for a second fee, the first individual's compatibility profile is added to a library or database of compatibility profiles of other individuals. According to one embodiment, the first individual's compatibility profile is permanently added to the library or database. According to another embodiment, the first individual's compatibility profile is added to the library or database for a fixed duration of time. According to this embodiment, the first individual can pay a fee for addition of the first individual's compatibility profile in the library or database for an additional fixed duration of time. According to one embodiment, the additional fixed duration of time can be renewed according to a subscription agreement and/or for a renewable subscription fee. According to this method, the individual is a subscriber. During the period of time the individual's compatibility profile is located in the library or database, the individual is a client.

According to one embodiment, the dating service is an online service offered through a dating website. According to another embodiment, the dating service is an online service offered through a social networking website. According to a further embodiment, the dating service is offered as a widget on a dating or social networking website and the users' encoded compatibility profile is displayed and/or shared with other users of the dating or social networking website. According to another embodiment, the widget is capable of comparing the compatibility profiles of two users of the dating or social networking website and determining whether the two users are a poor match, a reasonable match, an adequate match or an optimal match. According to a further embodiment, the widget is capable of comparing the compatibility profiles of a first individual and a group of second individuals, for example, the users of a defined user group (i.e., a geographic area, a university affiliation, or an interest or hobby), and determining whether any of the second individuals of the group is an optimal match, and, optionally, an adequate match, with the first individual.

According to one embodiment, the first individual can initiate a comparison of the first individual's compatibility profile with the compatibility profiles of one, more than one, or a group of second individuals. According to another embodiment, a second individual can be granted access or viewing rights by the first individual, for example, a friend of the first individual, can suggest and/or initiate a comparison of the first individual's compatibility profile with the compatibility profiles of one, more than one, or a group of second individuals.

Example. In one example according to the method of the invention, a service provides a body fluid collection kit to a first individual. The collection kit includes a device for collection of saliva, blood or other easily collectible body fluid containing a sufficient sample of the first individual's DNA, antibodies or other serum constituents. The collection kit is delivered to the first individual and returned to the service in person or through the mail.

According to this exemplary embodiment, a first individual requests a collection kit from the service, the service delivers a collection kit to the individual and the individual collects a saliva or blood sample using the collection kit. The individual returns the collection kit to the service and the service evaluates the sample. According to this embodiment, the service evaluates the sample by isolating the nucleic acid from the sample and identifying the SNPs or gene probes corresponding to alleles for at least four HLA loci and/or for the AVPR1A locus. The service then assigns a proprietary secure encoded reference to each allele at each HLA and/or AVPR1A locus to construct a compatibility profile. According to one embodiment, the compatibility profile comprises two strings of encoded references, each string comprising at least four encoded references, or one encoded reference for each HLA and/or AVPR1A allele evaluated.

The service communicates the compatibility profile to the individual in an encoded format to protect the underlying genetic information. The compatibility profile can be communicated to the individual in a format compatible for display on a website or other online forum. For example, the compatibility profile can be compatible for display on a personal website, a personal page of a social networking website, or on a widget associated with a personal page of a social networking site. Optionally, the service also stores the individual's compatibility profile in a database of compatibility profile data.

The service conducts a comparison between the first individual's compatibility profile and the compatibility profile of at least one other individual whose compatibility profile is stored in the compatibility profile database. The individual also conducts a comparison of their compatibility profile with the compatibility profile of another individual, for example, a friend or a member of a common group or network.

The comparison compares the allele encoded reference at each position in the first individual's compatibility profile to the allele encoded reference at the same position in the at least one other individual's compatibility profile. The number of similar allele encoded references corresponds to the compatibility score. According to this method, wherein four HLA loci are evaluated, a compatibility score of 0 results in a compatibility recommendation of “an optimal match” for sexual satisfaction and/or “an adequate match” for long term relationship potential. A compatibility score of 1 results in a compatibility recommendation of “a reasonable match” for sexual satisfaction and/or “a reasonable match” for long term relationship potential. A compatibility score of 2 or 3 results in a compatibility recommendation of “an adequate match” for sexual satisfaction and/or “undetermined” for long term relationship potential. A compatibility score of 4 results in a compatibility recommendation of “a poor match” for sexual satisfaction and/or “a poor match” for long term relationship potential. According to additional embodiments, for example, embodiments wherein more than four HLA loci are evaluated, the correlation between compatibility score and compatibility recommendation can be modified to accommodate the improved specificity of the evaluation.

The compatibility recommendation is communicated to the first individual. In one embodiment, the first individual is notified that a second individual was identified as an optimal match and/or an adequate match. The first individual can also be notified of the name and contact information of the match. The match can also be notified of the recommended match with the first individual and the name and contact information of the first individual.

TABLE 1
HLA genotyping SNPs

| Population | serotype | rs number |
|---|---|---|
| JPT | HLA-A*2402 | rs2275854 |
| CEU | HLA-A*0201 | rs2844821 |
| CEU | HLA-A*0201 | rs762324 |
| CHB | HLA-DQA*0301 | rs6903433 |
| YRI | HLA-DQB*0201 | rs4988889 |
| YRI | HLA-C*0401 | rs4386816 |
| YRI | HLA-DQA*0102 | rs204996 |
| CEU | HLA-DQA*0102 | rs6457594 |
| YRI | HLA-DQA*0501 | rs2284189 |
| CHB | HLA-A*0201 | rs4959037 |
| CHB | HLA-A*1101 | rs2517754 |
| CHB | HLA-A*0201 | rs892666 |
| CEU | HLA-DQA*0301 | rs3129883 |
| CEU | HLA-C*0702 | rs2001181 |
| CEU | HLA-C*0702 | rs3132572 |
| CEU | HLA-DQB*0602 | rs3135388 |
| JPT | HLA-DQA*0102 | rs3134975 |
| JPT | HLA-DQA*0102 | rs8180664 |
| CHB | HLA-DQB*0303 | rs2856683 |
| CEU | HLA-A*0101 | rs1611635 |
| CEU | HLA-A*0101 | rs10947088 |
| CEU | HLA-B*0702 | rs2596438 |
| CEU | HLA-B*0702 | rs805288 |
| JPT | HLA-DQA*0103 | rs1063355 |
| JPT | HLA-DQB*0303 | rs3998159 |
| CHB | HLA-C*0102 | rs4122190 |
| CEU | HLA-C*0701 | rs7382297 |
| CEU | HLA-DQA*0501 | rs2040406 |
| JPT | HLA-DRB*0901 | rs2187818 |
| JPT | HLA-DRB*0901 | rs7756741 |
| CEU | HLA-DQB*0301 | rs2856691 |
| YRI | HLA-B*5301 | rs6940467 |
| CHB | HLA-A*2402 | rs2734984 |
| YRI | HLA-DQA*0201 | rs2647012 |
| JPT | HLA-C*0102 | rs1264459 |
| JPT | HLA-C*0303 | rs2853950 |
| JPT | HLA-B*4002 | rs3130573 |
| JPT | HLA-B*4002 | rs3819299 |
| JPT | HLA-C*0102 | rs2535294 |
| CEU | HLA-DQB*0302 | rs2071876 |
| CHB | HLA-DQB*0601 | rs6928482 |
| CHB | HLA-DQA*0103 | rs7744001 |
| CHB | HLA-DQA*0103 | rs2187686 |
| YRI | HLA-A*3601 | rs259940 |
| YRI | HLA-A*3601 | rs261943 |
| CEU | HLA-B*0801 | rs2844535 |
| CEU | HLA-B*0801 | rs6457374 |
| CEU | HLA-DQA*0201 | rs2858333 |
| YRI | HLA-C*0701 | rs2524074 |
| YRI | HLA-C*0701 | rs3132499 |
| YRI | HLA-A*0301 | rs2524024 |
| JPT | HLA-C*0304 | rs3873386 |
| YRI | HLA-DRB*0701 | rs2647045 |
| JPT | HLA-A*0201 | rs6457110 |
| YRI | HLA-DRB*0701 | rs1800624 |
| JPT | HLA-A*0201 | rs9348834 |
| CEU | HLA-B*4402 | rs3130501 |
| CHB | HLA-B*4001 | rs2844580 |
| CHB | HLA-DQA*0501 | rs6908943 |
| CHB | HLA-B*4001 | rs2523694 |
| CEU | HLA-C*0501 | rs3130955 |
| CEU | HLA-C*0501 | rs364415 |
| CEU | HLA-C*0602 | rs887466 |
| JPT | HLA-A*3101 | rs1150739 |
| JPT | HLA-DQA*0101 | rs2647050 |
| JPT | HLA-DQA*0101 | rs6927022 |
| JPT | HLA-DQA*0101 | rs6932517 |
| CHB | HLA-B*4601 | rs2857595 |
| CHB | HLA-B*4601 | rs2243868 |
| YRI | HLA-A*2301 | rs2394186 |
| YRI | HLA-DQB*0402 | rs4947342 |
| YRI | HLA-DQB*0402 | rs2213586 |
| YRI | HLA-A*3303 | rs2523945 |
| YRI | HLA-A*2301 | rs1611717 |
| CEU | HLA-DRB*0404 | rs2736157 |
| CEU | HLA-DRB*0404 | rs3115572 |
| JPT | HLA-DRB*0405 | rs2395185 |
| JPT | HLA-DRB*0405 | rs411326 |
| JPT | HLA-DRB*1502 | rs7382794 |
| JPT | HLA-DRB*1502 | rs3135365 |
| JPT | HLA-DRB*1501 | rs6919855 |
| JPT | HLA-DRB*1501 | rs6901830 |
| CEU | HLA-DRB*0701 | rs241398 |
| YRI | HLA-DQA*0101 | rs2858330 |
| CHB | HLA-DQA*0101 | rs532098 |
| CHB | HLA-DQA*0101 | rs482044 |
| CEU | HLA-DRB*0701 | rs2647087 |
| CHB | HLA-DQA*0101 | rs8365 |
| YRI | HLA-DQA*0101 | rs1612904 |
| YRI | HLA-DQA*0101 | rs3134605 |
| CEU | HLA-DRB*0301 | rs2040410 |
| CEU | HLA-A*0301 | rs9380122 |
| YRI | HLA-A*3001 | rs2057727 |
| YRI | HLA-DRB*0301 | rs3129763 |
| YRI | HLA-DRB*0302 | rs3129878 |
| YRI | HLA-DRB*0302 | rs7764856 |
| YRI | HLA-DRB*0301 | rs9277489 |
| YRI | HLA-A*3001 | rs1633005 |
| JPT | HLA-DRB*1302 | rs2157339 |
| JPT | HLA-DRB*1302 | rs6936204 |
| JPT | HLA-B*5201 | rs2596560 |
| JPT | HLA-DQB*0401 | rs2300825 |
| JPT | HLA-C*1202 | rs6923313 |
| JPT | HLA-DQB*0302 | rs393906 |
| CHB | HLA-DRB*0803 | rs1041885 |
| CHB | HLA-DRB*0803 | rs3129859 |
| CHB | HLA-DRB*0803 | rs154984 |
| CEU | HLA-DRB*0401 | rs3817964 |
| CEU | HLA-A*2402 | rs3893538 |
| CEU | HLA-DRB*0401 | rs6910071 |
| CEU | HLA-DRB*0401 | rs660895 |
| CEU | HLA-DRB*0101 | rs6457614 |
| CEU | HLA-A*2402 | rs2523933 |
| YRI | HLA-B*3501 | rs2249876 |
| YRI | HLA-B*5201 | rs2394401 |
| YRI | HLA-C*1701 | rs2524069 |
| YRI | HLA-C*1701 | rs3096702 |
| YRI | HLA-DRB*1301 | rs3134942 |
| YRI | HLA-DQA*0103 | rs3135338 |
| YRI | HLA-DRB*1301 | rs7451962 |
| YRI | HLA-DRB*1301 | rs3763308 |
| CEU | HLA-C*0401 | rs9461684 |
| YRI | HLA-DQA*0103 | rs2858867 |
| YRI | HLA-B*1510 | rs2523638 |
| YRI | HLA-B*3501 | rs2844498 |
| JPT | HLA-C*1402 | rs130074 |
| JPT | HLA-B*4403 | rs2844523 |
| JPT | HLA-DQB*0604 | rs3892710 |
| JPT | HLA-C*1402 | rs6457300 |
| JPT | HLA-B*5101 | rs6933050 |
| JPT | HLA-DQA*0501 | rs2097432 |
| JPT | HLA-DQB*0604 | rs6457713 |
| JPT | HLA-C*1403 | rs2523653 |
| CHB | HLA-C*0303 | rs2156875 |
| CHB | HLA-B*5101 | rs2471980 |
| CHB | HLA-A*3303 | rs2524005 |
| CHB | HLA-C*0602 | rs3130457 |
| CHB | HLA-B*5101 | rs3905495 |
| CHB | HLA-DRB*1202 | rs6916742 |
| CHB | HLA-DRB*0405 | rs2516049 |
| CHB | HLA-DRB*1202 | rs646984 |
| CHB | HLA-DQB*0502 | rs6906021 |
| CHB | HLA-DQA*0601 | rs3129718 |
| YRI | HLA-DRB*0804 | rs3129954 |
| YRI | HLA-DRB*0804 | rs507778 |
| YRI | HLA-DRB*1104 | rs558702 |
| YRI | HLA-B*4201 | rs2273017 |
| YRI | HLA-DRB*1104 | rs7744293 |
| YRI | HLA-B*0702 | rs2523618 |
| CEU | HLA-B*1501 | rs3819294 |
| CEU | HLA-B*1501 | rs3094117 |
| JPT | HLA-A*2601 | rs1045251 |
| JPT | HLA-A*2601 | rs3132571 |
| JPT | HLA-A*2601 | rs3823339 |
| JPT | HLA-B*4601 | rs3873334 |
| CHB | HLA-DRB*0701 | rs2395177 |
| CHB | HLA-DRB*0301 | rs3129299 |
| CHB | HLA-DQA*0201 | rs3844313 |
| CHB | HLA-DRB*0301 | rs5000803 |
| CHB | HLA-DRB*1501 | rs620202 |
| CHB | HLA-DRB*1501 | rs6903608 |
| CHB | HLA-DRB*0301 | rs7769979 |
| CHB | HLA-DRB*1501 | rs7773756 |
| CHB | HLA-DQB*0302 | rs9275184 |
| CHB | HLA-DQB*0401 | rs2077580 |
| CHB | HLA-DQA*0201 | rs7763805 |
| CEU | HLA-C*0303 | rs1265100 |
| CEU | HLA-B*5701 | rs2395029 |
| CEU | HLA-C*0303 | rs7745906 |
| YRI | HLA-DRB*1101 | rs12191360 |
| YRI | HLA-DQB*0603 | rs210139 |
| YRI | HLA-DRB*1101 | rs2395150 |
| YRI | HLA-B*5801 | rs2523608 |
| YRI | HLA-B*1503 | rs2844533 |
| YRI | HLA-DQA*0301 | rs6457617 |
| YRI | HLA-C*0702 | rs9264731 |
| YRI | HLA-A*6802 | rs6457116 |
| YRI | HLA-DQB*0603 | rs3135006 |
| YRI | HLA-DRB*1302 | rs7756467 |
| JPT | HLA-DRB*0802 | rs2239800 |
| JPT | HLA-B*0702 | rs2523480 |
| JPT | HLA-B*3501 | rs2596501 |
| JPT | HLA-B*3501 | rs2844521 |
| JPT | HLA-DRB*0802 | rs3129888 |
| JPT | HLA-B*5401 | rs1634789 |
| JPT | HLA-C*0801 | rs2524227 |
| JPT | HLA-B*5401 | rs1063632 |
| CHB | HLA-B*1302 | rs12212594 |
| CHB | HLA-DRB*1201 | rs206777 |
| CHB | HLA-DRB*1201 | rs2856718 |
| CHB | HLA-B*5401 | rs3130786 |
| CHB | HLA-A*0206 | rs6457109 |
| CHB | HLA-B*1302 | rs7761138 |
| CHB | HLA-A*0206 | rs9260988 |
| CHB | HLA-B*5401 | rs3819284 |
| CHB | HLA-DRB*1201 | rs2105903 |
| YRI | HLA-C*0804 | rs2523554 |
| CEU | HLA-B*3501 | rs2523685 |
| CEU | HLA-B*3501 | rs2532934 |
| YRI | HLA-C*0802 | rs652888 |
| YRI | HLA-C*0804 | rs1265180 |
| CEU | HLA-DRB*1101 | rs434841 |
| YRI | HLA-A*3002 | rs2517671 |
| YRI | HLA-A*3002 | rs2844846 |
| JPT | HLA-DRB*0101 | rs13209234 |
| JPT | HLA-B*3901 | rs1811197 |
| JPT | HLA-DRB*1201 | rs2294881 |
| JPT | HLA-B*3901 | rs3134931 |
| JPT | HLA-DRB*1201 | rs4569 |
| JPT | HLA-B*4006 | rs986475 |
| JPT | HLA-DRB*1201 | rs1548306 |
| JPT | HLA-A*2603 | rs2301751 |
| JPT | HLA-B*4006 | rs2075788 |
| CEU | HLA-DRB*1301 | rs2395173 |
| CHB | HLA-C*0401 | rs12662501 |
| CHB | HLA-DRB*1401 | rs1799964 |
| CHB | HLA-B*5201 | rs2844586 |
| CHB | HLA-C*1202 | rs3094663 |
| CHB | HLA-C*0302 | rs4713438 |
| CHB | HLA-B*5801 | rs4713518 |
| CHB | HLA-B*4006 | rs8283 |
| CHB | HLA-B*5201 | rs1062470 |
| CHB | HLA-C*0304 | rs4947248 |
| CHB | HLA-C*1202 | rs2073723 |
| CHB | HLA-C*1402 | rs2073716 |
| CHB | HLA-DRB*1401 | rs3129961 |
| CHB | HLA-B*5801 | rs3134792 |
| CHB | HLA-C*1402 | rs3095301 |
| CHB | HLA-C*0304 | rs6457350 |
| CHB | HLA-C*0302 | rs1265155 |
| CHB | HLA-DQB*0503 | rs241446 |
| CHB | HLA-DQB*0602 | rs2621426 |
| YRI | HLA-C*0302 | rs2074488 |
| YRI | HLA-B*5101 | rs2523451 |
| YRI | HLA-B*5101 | rs379464 |
| YRI | HLA-DQB*0605 | rs419132 |
| YRI | HLA-A*0201 | rs4713240 |
| YRI | HLA-DQB*0605 | rs5021448 |
| YRI | HLA-A*0201 | rs3132682 |
| YRI | HLA-A*3402 | rs1610606 |
| YRI | HLA-A*7401 | rs9468675 |
| YRI | HLA-A*3402 | rs4959036 |
| CEU | HLA-B*4001 | rs1265110 |
| CEU | HLA-B*1801 | rs2523589 |
| CEU | HLA-A*2501 | rs3094121 |
| CEU | HLA-B*1801 | rs3129996 |
| CEU | HLA-B*4001 | rs4711240 |
| CEU | HLA-C*0304 | rs4713391 |
| CEU | HLA-A*1101 | rs29233 |
| JPT | HLA-DRB*0801 | rs2071469 |
| JPT | HLA-DRB*0801 | rs3077 |
| JPT | HLA-DRB*0803 | rs412735 |
| JPT | HLA-B*6701 | rs761188 |
| JPT | HLA-DRB*1401 | rs4151657 |
| YRI | HLA-DRB*0102 | rs14004 |
| CEU | HLA-A*6801 | rs1610714 |
| CEU | HLA-DRB*1401 | rs1794265 |
| CEU | HLA-A*6801 | rs2571375 |
| CEU | HLA-DRB*1401 | rs2763979 |
| CHB | HLA-DRB*0403 | rs2075800 |
| CHB | HLA-A*0203 | rs2269706 |
| CHB | HLA-DRB*0403 | rs2395175 |
| CHB | HLA-A*0203 | rs2844713 |
| CHB | HLA-DQB*0402 | rs6937034 |
| CHB | HLA-B*1301 | rs707913 |
| CHB | HLA-DRB*1101 | rs1383261 |
| CHB | HLA-B*1518 | rs4084091 |
| CHB | HLA-DQB*0402 | rs2076528 |
| CHB | HLA-B*3802 | rs3828875 |
| CHB | HLA-C*1203 | rs6929434 |
| CHB | HLA-A*3101 | rs3823318 |
| CEU | HLA-B*5101 | rs2844657 |
| CEU | HLA-A*3201 | rs3130244 |
| CEU | HLA-B*5101 | rs4947296 |
| CEU | HLA-C*0704 | rs2256583 |
| CEU | HLA-C*0704 | rs2524050 |
| CEU | HLA-C*1502 | rs3764808 |
| CEU | HLA-B*5101 | rs2516675 |
| YRI | HLA-DRB*0901 | rs1061808 |
| YRI | HLA-DRB*1102 | rs2072915 |
| YRI | HLA-DRB*0901 | rs2242656 |
| YRI | HLA-DRB*1102 | rs2395153 |
| YRI | HLA-DRB*1102 | rs241424 |
| YRI | HLA-B*5703 | rs2523586 |
| YRI | HLA-A*0202 | rs9261488 |
| YRI | HLA-B*1302 | rs397596 |
| YRI | HLA-DQB*0503 | rs2856717 |
| YRI | HLA-A*0202 | rs3094636 |
| YRI | HLA-A*3301 | rs7749944 |
| JPT | HLA-DRB*1101 | rs1799911 |
| JPT | HLA-DRB*1405 | rs3093953 |
| JPT | HLA-DRB*1405 | rs440454 |
| JPT | HLA-B*5901 | rs2076536 |
| JPT | HLA-DRB*0403 | rs3763349 |
| JPT | HLA-DRB*0403 | rs169494 |
| JPT | HLA-DRB*0406 | rs6936863 |
| JPT | HLA-DRB*1101 | rs4424079 |
| CEU | HLA-B*4403 | rs12526186 |
| CEU | HLA-C*0202 | rs4122189 |
| CEU | HLA-A*2601 | rs4678 |
| CEU | HLA-DRB*1302 | rs6901541 |
| CEU | HLA-B*4403 | rs7747738 |
| CEU | HLA-DRB*1302 | rs4434496 |
| CEU | HLA-DRB*1601 | rs6923504 |
| CHB | HLA-B*3501 | rs1264307 |
| CHB | HLA-A*0302 | rs1557608 |
| CHB | HLA-DRB*1602 | rs2227139 |
| CHB | HLA-DRB*0401 | rs2239705 |
| CHB | HLA-DRB*0801 | rs2763982 |
| CHB | HLA-DRB*1502 | rs2858880 |
| CHB | HLA-B*3501 | rs3128982 |
| CHB | HLA-A*0301 | rs3130785 |
| CHB | HLA-DQA*0401 | rs4711312 |
| CHB | HLA-DRB*0801 | rs4713479 |
| CHB | HLA-A*3201 | rs9468692 |
| CHB | HLA-A*0101 | rs1264709 |
| CHB | HLA-DRB*0802 | rs1044506 |
| CHB | HLA-DRB*1602 | rs7769073 |
| CHB | HLA-B*6701 | rs2239523 |
| CHB | HLA-A*0302 | rs1736924 |
| CHB | HLA-DRB*0802 | rs11757862 |
| YRI | HLA-A*0101 | rs10807055 |
| YRI | HLA-DQB*0604 | rs1978029 |
| CEU | HLA-DRB*0403 | rs206765 |
| CEU | HLA-C*1402 | rs2240061 |
| CEU | HLA-C*0802 | rs2442719 |
| CEU | HLA-B*5201 | rs2517424 |
| YRI | HLA-A*0205 | rs2523734 |
| CEU | HLA-A*2301 | rs2534825 |
| YRI | HLA-A*0101 | rs2844775 |
| CEU | HLA-A*2301 | rs3025623 |
| YRI | HLA-A*6602 | rs3115592 |
| YRI | HLA-DRB*0101 | rs3135391 |
| CEU | HLA-DRB*0403 | rs399604 |
| YRI | HLA-DRB*1201 | rs4248166 |
| YRI | HLA-DRB*0101 | rs439844 |
| YRI | HLA-DRB*1201 | rs6918223 |
| YRI | HLA-A*2902 | rs7741100 |
| YRI | HLA-C*1801 | rs2524089 |
| YRI | HLA-A*6801 | rs2524198 |
| YRI | HLA-C*1801 | rs2524040 |
| CEU | HLA-B*5001 | rs915653 |
| CEU | HLA-DRB*0403 | rs7454108 |
| CEU | HLA-C*1402 | rs2517439 |
| CEU | HLA-C*0802 | rs2524048 |
| YRI | HLA-A*0205 | rs3132672 |
| CEU | HLA-C*1203 | rs2248902 |
| CEU | HLA-B*5201 | rs12526820 |
| YRI | HLA-A*6801 | rs2735068 |
| CEU | HLA-A*2902 | rs2844659 |
| YRI | HLA-B*4403 | rs2769 |
| CEU | HLA-C*0102 | rs9380234 |
| YRI | HLA-A*6602 | rs2523960 |
| CEU | HLA-DQB*0604 | rs10573 |
| YRI | HLA-A*2902 | rs2523807 |
| YRI | HLA-DQB*0604 | rs3129848 |
| CEU | HLA-B*3503 | rs1264375 |
| CEU | HLA-DRB*1303 | rs2050191 |
| CEU | HLA-B*1402 | rs2524160 |
| CEU | HLA-B*3503 | rs2857605 |
| CEU | HLA-DRB*1103 | rs4639334 |
| CEU | HLA-DRB*0407 | rs7774197 |
| CEU | HLA-DRB*1303 | rs424232 |
| CEU | HLA-B*3701 | rs2853931 |
| CEU | HLA-B*1402 | rs9368673 |
| CEU | HLA-C*1202 | rs3869115 |
| CEU | HLA-B*3906 | rs2844603 |
| CEU | HLA-A*0205 | rs6906270 |
| CEU | HLA-B*4901 | rs2394985 |
| CEU | HLA-DRB*0407 | rs417812 |
| CEU | HLA-B*3906 | rs9468859 |
| CEU | HLA-DRB*1103 | rs210180 |
| CEU | HLA-C*1202 | rs396960 |
| JPT | HLA-B*1518 | rs1150758 |
| JPT | HLA-DQA*0601 | rs2071293 |
| CHB | HLA-B*1511 | rs2074491 |
| JPT | HLA-A*2404 | rs2240619 |
| JPT | HLA-C*0103 | rs2267644 |
| CHB | HLA-C*0704 | rs2395031 |
| JPT | HLA-B*5601 | rs2429657 |
| JPT | HLA-B*4402 | rs2517512 |
| JPT | HLA-B*1301 | rs2844573 |
| CHB | HLA-B*3901 | rs2844575 |
| CHB | HLA-B*1502 | rs2844682 |
| JPT | HLA-B*5601 | rs2853926 |
| JPT | HLA-DQB*0603 | rs2857597 |
| CHB | HLA-DRB*1444 | rs3129949 |
| CHB | HLA-DRB*0410 | rs3130267 |
| CHB | HLA-B*5601 | rs3130977 |
| JPT | HLA-DRB*0812 | rs3763350 |
| CHB | HLA-DRB*1444 | rs429853 |
| CHB | HLA-B*3701 | rs4947332 |
| JPT | HLA-B*4801 | rs4959069 |
| JPT | HLA-DRB*1301 | rs544167 |
| JPT | HLA-C*0103 | rs660550 |
| CHB | HLA-B*4002 | rs6930444 |
| JPT | HLA-DQB*0605 | rs3129267 |
| JPT | HLA-A*3001 | rs3218822 |
| CHB | HLA-B*5901 | rs3094188 |
| CHB | HLA-B*8101 | rs2507997 |
| CHB | HLA-B*8101 | rs3134954 |
| CHB | HLA-B*3801 | rs9295863 |
| JPT | HLA-C*1502 | rs2240066 |
| JPT | HLA-A*0301 | rs2524172 |
| CHB | HLA-DRB*0410 | rs4713521 |
| CHB | HLA-B*4002 | rs3130655 |
| CHB | HLA-DRB*1301 | rs3873444 |
| CHB | HLA-DQB*0603 | rs3806155 |
| CHB | HLA-B*1502 | rs3909184 |
| JPT | HLA-DQB*0402 | rs926594 |
| JPT | HLA-DQA*0601 | rs2736182 |
| JPT | HLA-C*0302 | rs7744914 |
| JPT | HLA-C*0704 | rs3093542 |
| CHB | HLA-DRB*0404 | rs9404991 |
| JPT | HLA-B*1301 | rs1264513 |
| CHB | HLA-DRB*1407 | rs4248157 |
| JPT | HLA-DQB*0502 | rs1367731 |
| JPT | HLA-B*5801 | rs3095318 |
| YRI | HLA-B*1801 | rs1051791 |
| JPT | HLA-B*4601 | rs2251396 |
| CEU | HLA-C*0304 | rs3130434 |
| CEU | HLA-DQB*0603 | rs3135461 |
| CEU | HLA-DQB*0604 | rs7766854 |
| CHB | HLA-B*1501 | rs2524178 |
| CHB | HLA-B*5701 | rs3093726 |
| YRI | HLA-DRB*1503 | rs4599680 |
| CHB | HLA-B*0801 | rs4248151 |
| JPT | HLA-C*0401 | rs1632856 |
| CHB | HLA-B*3802 | rs2844725 |
| JPT | HLA-DQB*0402 | rs7743506 |
| CEU | HLA-B*3701 | rs7772218 |
| CEU | HLA-B*1302 | rs12191164 |
| YRI | HLA-C*1505 | rs3216869 |
| CEU | HLA-B*4002 | rs3819285 |
| YRI | HLA-C*1505 | rs7381371 |
| CEU | HLA-A*2902 | rs7453068 |
| YRI | HLA-B*4501 | rs7453631 |
| CHB | HLA-A*6801 | rs2844800 |
| CEU | HLA-DQB*0502 | rs5875391 |
| CEU | HLA-DRB*1601 | rs7452076 |
| JPT | HLA-DRB*1403 | rs3819703 |
| YRI | HLA-B*5703 | rs3998357 |
| YRI | HLA-B*5703 | rs7451258 |
| CEU | HLA-A*3201 | rs1611578 |
| CEU | HLA-C*1502 | rs4379333 |
| CHB | HLA-A*3101 | rs1061235 |
| CHB | HLA-DQB*0604 | rs11758998 |
| CHB | HLA-DQB*0402 | rs1694112 |
| JPT | HLA-DRB*0801 | rs2116259 |
| JPT | HLA-DRB*0803 | rs3834856 |
| CEU | HLA-A*2501 | rs3835309 |
| CHB | HLA-DRB*1401 | rs9469185 |
| JPT | HLA-A*2603 | rs2745409 |
| JPT | HLA-DRB*0101 | rs9276814 |
| YRI | HLA-B*4901 | rs11967289 |
| CEU | HLA-DRB*1101 | rs5875439 |
| CEU | HLA-DQA*0103 | rs2157051 |
| JPT | HLA-B*1501 | rs12208824 |
| JPT | HLA-B*1501 | rs6928547 |
| JPT | HLA-B*4001 | rs7381331 |
| YRI | HLA-B*5801 | rs1058026 |
| YRI | HLA-DQB*0603 | rs3918153 |
| YRI | HLA-DRB*1101 | rs4713559 |
| YRI | HLA-B*5801 | rs6929932 |
| CEU | HLA-DQB*0303 | rs3834857 |
| JPT | HLA-A*1101 | rs2893998 |
| JPT | HLA-B*4601 | rs3130536 |
| YRI | HLA-DRB*1303 | rs11756657 |
| CHB | HLA-A*3303 | rs2855591 |
| CHB | HLA-B*5101 | rs7450800 |
| YRI | HLA-B*5201 | rs2256965 |
| YRI | HLA-C*1701 | rs5875311 |
| JPT | HLA-A*0206 | rs2517699 |
| YRI | HLA-DRB*0301 | rs9275229 |
| CEU | HLA-A*0301 | rs9259817 |
| CEU | HLA-DRB*0701 | rs7745002 |
| YRI | HLA-A*3303 | rs6921921 |
| CEU | HLA-C*0501 | rs4151665 |
| YRI | HLA-DRB*0701 | rs3828846 |
| YRI | HLA-DQA*0401 | rs1061172 |
| CHB | HLA-C*0801 | rs2524100 |
| JPT | HLA-C*0303 | rs4084093 |
| JPT | HLA-C*0303 | rs6457388 |
| CHB | HLA-A*2402 | rs1611589 |
| YRI | HLA-DQB*0301 | rs1056315 |
| CEU | HLA-DQA*0501 | rs10485326 |
| CHB | HLA-C*0102 | rs3834326 |
| JPT | HLA-DQB*0303 | rs2395533 |
| CHB | HLA-A*1101 | rs7745235 |
| JPT | HLA-DQA*0301 | rs2856716 |
| JPT | HLA-DQA*0301 | rs5875382 |

TABLE 2

| | | | |
|---|---|---|---|
| A*01010101 | A*2615 | A*0130 | A*022002 |
| A*01010102N | A*29010101 | A*020102 | A*0221 |
| A*0104N | A*29010102N | A*020103 | A*0222 |
| A*0109 | A*290201 | A*020104 | A*0224 |
| A*0111N | A*300201 | A*020105 | A*0225 |
| A*0114 | A*3104 | A*020106 | A*0226 |
| A*0116N | A*3114N | A*020107 | A*0227 |
| A*0120 | A*320101 | A*020108 | A*0228 |
| A*02010101 | A*3307 | A*020109 | A*0229 |
| A*02010102L | A*680101 | A*020110 | A*0230 |
| A*02010103 | A*68020101 | A*020111 | A*0231 |
| A*0205 | A*68020102 | A*020112 | A*0233 |
| A*0232N | A*68020103 | A*020113 | A*0234 |
| A*0243N | A*680202 | A*020114 | A*023501 |
| A*0251 | A*6808 | A*020115 | A*023502 |
| A*0253N | A*6817 | A*020117 | A*023503 |
| A*0257 | A*6818N | A*020118 | A*0236 |
| A*0260 | A*6822 | A*020119 | A*0237 |
| A*0265 | A*010102 | A*0202 | A*0238 |
| A*0268 | A*010103 | A*020301 | A*0239 |
| A*0277 | A*010104 | A*020302 | A*0240 |
| A*0281 | A*010105 | A*0204 | A*0241 |
| A*0289 | A*0102 | A*020601 | A*0242 |
| A*03010101 | A*0103 | A*020602 | A*0244 |
| A*03010102N | A*0106 | A*020603 | A*0245 |
| A*03010103 | A*0107 | A*020604 | A*0246 |
| A*0311N | A*0108 | A*020605 | A*0247 |
| A*0321N | A*0110 | A*020606 | A*0248 |
| A*0336N | A*0112 | A*0207 | A*0249 |
| A*1105 | A*0113 | A*0208 | A*0250 |
| A*1125 | A*0115N | A*0209 | A*0252 |
| A*2307N | A*0117 | A*0210 | A*0254 |
| A*2309 | A*0118N | A*0211 | A*0255 |
| A*24020101 | A*0119 | A*0212 | A*0256 |
| A*24020102L | A*0121 | A*0213 | A*0258 |
| A*240203 | A*0122N | A*0214 | A*0259 |
| A*240210 | A*0123 | A*0215N | A*0261 |
| A*2409N | A*0124 | A*0216 | A*0262 |
| A*2411N | A*0125 | A*021701 | A*0263 |
| A*2461 | A*0126 | A*021702 | A*0264 |
| A*2486N | A*0127N | A*0218 | A*0266 |
| A*260101 | A*0128 | A*0219 | A*0267 |
| A*2611N | A*0129 | A*022001 | A*0269 |
| A*0270 | A*0314 | A*1111 | A*2319Q |
| A*0271 | A*0315 | A*1112 | A*240202 |
| A*0272 | A*0316 | A*1113 | A*240204 |
| A*0273 | A*0317 | A*1114 | A*240205 |
| A*027401 | A*0318 | A*111501 | A*240206 |
| A*027402 | A*0319 | A*111502 | A*240207 |
| A*0275 | A*0320 | A*1116 | A*240208 |
| A*0276 | A*0322 | A*1117 | A*240209 |
| A*0278 | A*0323 | A*1118 | A*240211 |
| A*0279 | A*0324 | A*1119 | A*240212 |
| A*0280 | A*0325 | A*1120 | A*240213 |
| A*0282N | A*0326 | A*1121N | A*240214 |
| A*0283N | A*0327 | A*1122 | A*240215 |
| A*0284 | A*0328 | A*1123 | A*240216 |
| A*0285 | A*0329 | A*112401 | A*240301 |
| A*0286 | A*0330 | A*112402 | A*240302 |
| A*0287 | A*0331 | A*1126 | A*2404 |
| A*0288N | A*0332 | A*1127 | A*2405 |
| A*0290 | A*0333 | A*1129 | A*2406 |
| A*0291 | A*0334 | A*1130 | A*2407 |
| A*0292 | A*0335 | A*1131 | A*2408 |
| A*0293 | A*0337 | A*1132 | A*2410 |
| A*0294N | A*0338 | A*1133 | A*241301 |
| A*0295 | A*0339 | A*1134 | A*241302 |
| A*0296 | A*110101 | A*1135 | A*2414 |
| A*0297 | A*110102 | A*1136 | A*2415 |
| A*0299 | A*110103 | A*2301 | A*2417 |
| A*030102 | A*110104 | A*2302 | A*2418 |
| A*030103 | A*110105 | A*230301 | A*2419 |
| A*030104 | A*110106 | A*230302 | A*2420 |
| A*030105 | A*110107 | A*2304 | A*2421 |
| A*030106 | A*110108 | A*2305 | A*2422 |
| A*0302 | A*110109 | A*2306 | A*2423 |
| A*0303N | A*110201 | A*2308N | A*2424 |
| A*0304 | A*110202 | A*2310 | A*2425 |
| A*0305 | A*110203 | A*2311N | A*2426 |
| A*0306 | A*1103 | A*2312 | A*2427 |
| A*0307 | A*1104 | A*2313 | A*2428 |
| A*0308 | A*1106 | A*2314 | A*2429 |
| A*0309 | A*1107 | A*2315 | A*2430 |
| A*0310 | A*1108 | A*2316 | A*2431 |
| A*0312 | A*1109 | A*2317 | A*2432 |
| A*0313 | A*1110 | A*2318 | A*2433 |
| A*2434 | A*2479 | A*2622 | A*3009 |
| A*2435 | A*2480 | A*2623 | A*3010 |
| A*2436N | A*2481 | A*2624 | A*301101 |
| A*2437 | A*2482 | A*2625N | A*301102 |
| A*2438 | A*2483N | A*2626 | A*3012 |
| A*2439 | A*2484N | A*2627 | A*3013 |
| A*2440N | A*2485 | A*2628 | A*3014L |
| A*2441 | A*2487 | A*2629 | A*3015 |
| A*2442 | A*2488 | A*2630 | A*3016 |
| A*2443 | A*2489 | A*2631 | A*3017 |
| A*2444 | A*2490N | A*2632 | A*3018 |
| A*2445N | A*2491 | A*2633 | A*3019 |
| A*2446 | A*250101 | A*2634 | A*3020 |
| A*2447 | A*250102 | A*2635 | A*3022 |
| A*2448N | A*2502 | A*2636 | A*3023 |
| A*2449 | A*2503 | A*2637 | A*3024 |
| A*2450 | A*2504 | A*290202 | A*3025 |
| A*2451 | A*2505 | A*290203 | A*310102 |
| A*2452 | A*2506 | A*2903 | A*310103 |
| A*2453 | A*260102 | A*2904 | A*3102 |
| A*2454 | A*260103 | A*2905 | A*3103 |
| A*2455 | A*260104 | A*2906 | A*3105 |
| A*2456 | A*260105 | A*2907 | A*3106 |
| A*2457 | A*260106 | A*2908N | A*3107 |
| A*2458 | A*2602 | A*2909 | A*3108 |
| A*2459 | A*2603 | A*2910 | A*3109 |
| A*2460N | A*2604 | A*2911 | A*3110 |
| A*2462 | A*2605 | A*2912 | A*3111 |
| A*2463 | A*2606 | A*2913 | A*3112 |
| A*2464 | A*260701 | A*2914 | A*3113 |
| A*2466 | A*260702 | A*2915 | A*3115 |
| A*2467 | A*2608 | A*2916 | A*3116 |
| A*2468 | A*2609 | A*2917 | A*3117 |
| A*2469 | A*2610 | A*300101 | A*3118 |
| A*2470 | A*2612 | A*300102 | A*3119 |
| A*2471 | A*2613 | A*300202 | A*3120 |
| A*2472 | A*2614 | A*300203 | A*3121 |
| A*2473 | A*2616 | A*300204 | A*3122 |
| A*2474 | A*2617 | A*3003 | A*320102 |
| A*2475 | A*2618 | A*3004 | A*320103 |
| A*2476 | A*2619 | A*3006 | A*3202 |
| A*2477 | A*2620 | A*3007 | A*3203 |
| A*2478 | A*2621 | A*3008 | A*3204 |
| A*3205 | A*4301 | A*6835 | A*9221 |
| A*3206 | A*6601 | A*6836 | A*9222 |
| A*3207 | A*6602 | A*6837 | A*9223 |
| A*3208 | A*6603 | A*6838 | A*9224 |
| A*3209 | A*6604 | A*6839 | A*9225N |
| A*3210 | A*6605 | A*6840 | A*9226 |
| A*3211Q | A*6606 | A*6841 | A*9227 |
| A*3212 | A*6607 | A*6842 | A*9228 |
| A*3213 | A*680102 | A*6843 | A*9229 |
| A*3214 | A*680103 | A*6901 | A*9230 |
| A*3215 | A*680104 | A*7401 | A*9231 |
| A*3216 | A*680105 | A*7402 | A*9232 |
| A*3301 | A*680106 | A*7403 | A*9233 |
| A*330301 | A*680107 | A*7404 | A*9234 |
| A*330302 | A*680301 | A*7405 | A*9235 |
| A*3304 | A*680302 | A*7406 | A*9236 |
| A*3305 | A*6804 | A*7407 | A*9237 |
| A*3306 | A*6805 | A*7408 | A*9238 |
| A*3308 | A*6806 | A*7409 | A*9239 |
| A*3309 | A*6807 | A*7410 | A*9240 |
| A*3310 | A*6809 | A*7411 | A*9241 |
| A*3311 | A*6810 | A*7412N | A*9242 |
| A*3312 | A*6811N | A*8001 | A*9243 |
| A*3313 | A*6812 | A*9201 | A*9244 |
| A*3314 | A*6813 | A*9202 | A*9245 |
| A*3315 | A*6814 | A*9203 | A*9246 |
| A*3316 | A*6815 | A*9204 | A*9247 |
| A*3317 | A*6816 | A*9205 | A*9248 |
| A*3318 | A*6819 | A*9206 | B*070201 |
| A*3319 | A*6820 | A*9207 | B*0733 |
| A*340101 | A*6821 | A*9208 | B*0741 |
| A*340102 | A*6823 | A*9209 | B*0744 |
| A*3402 | A*6824 | A*9210 | B*0750 |
| A*3403 | A*6825 | A*9211 | B*080101 |
| A*3404 | A*6826 | A*9212 | B*0808N |
| A*3405 | A*6827 | A*9213N | B*0819N |
| A*3406 | A*6828 | A*9214 | B*0820 |
| A*3407 | A*6829 | A*9215 | B*0833 |
| A*3408 | A*6830 | A*9216 | B*130201 |
| A*3601 | A*6831 | A*9217 | B*130203 |
| A*3602 | A*6832 | A*9218 | B*1308Q |
| A*3603 | A*6833 | A*9219 | B*1315 |
| A*3604 | A*6834 | A*9220 | B*140201 |
| B*1407N | B*4423N | B*0706 | B*0751 |
| B*15010101 | B*4446 | B*0707 | B*0752 |
| B*15010102N | B*4449 | B*0708 | B*0753 |
| B*1504 | B*4456N | B*0709 | B*0754 |
| B*15170101 | B*4501 | B*0710 | B*0755 |
| B*15170102 | B*4504 | B*0711 | B*0756 |
| B*1542 | B*460101 | B*0712 | B*0757 |
| B*1566 | B*47010101 | B*0713 | B*0758 |
| B*1577 | B*47010102 | B*0714 | B*0759 |
| B*1583 | B*480101 | B*0715 | B*0760 |
| B*180101 | B*4808 | B*0716 | B*0761 |
| B*1803 | B*4901 | B*0717 | B*0762 |
| B*1817N | B*5001 | B*071801 | B*0763 |
| B*1826 | B*510101 | B*071802 | B*0764 |
| B*270502 | B*510102 | B*0719 | B*0765 |
| B*2706 | B*5142 | B*0720 | B*0766 |
| B*2732 | B*520101 | B*0721 | B*080102 |
| B*350101 | B*530101 | B*072201 | B*080103 |
| B*351402 | B*5311 | B*072202 | B*080104 |
| B*3541 | B*550101 | B*0723 | B*080105 |
| B*370101 | B*550103 | B*0724 | B*0802 |
| B*380101 | B*5512 | B*0725 | B*0803 |
| B*380201 | B*5524 | B*0726 | B*0804 |
| B*3814 | B*570101 | B*0727 | B*0805 |
| B*39010101 | B*5706 | B*0728 | B*0806 |
| B*39010102L | B*5711 | B*0729 | B*0807 |
| B*390103 | B*580101 | B*0730 | B*0809 |
| B*3910 | B*6702 | B*0731 | B*0810 |
| B*391302 | B*7301 | B*0732 | B*0811 |
| B*3934 | B*7801 | B*0734 | B*0812 |
| B*400102 | B*8202 | B*0735 | B*0813 |
| B*400201 | B*9508 | B*0736 | B*0814 |
| B*40060101 | B*070202 | B*0737 | B*0815 |
| B*40060102 | B*070203 | B*0738 | B*0816 |
| B*407201 | B*070204 | B*0739 | B*0817 |
| B*4079 | B*070205 | B*0740 | B*0818 |
| B*4101 | B*070206 | B*0742 | B*0821 |
| B*4201 | B*070207 | B*0743 | B*0822 |
| B*4208 | B*0703 | B*0745 | B*0823 |
| B*44020101 | B*0704 | B*0746 | B*0824 |
| B*44020102S | B*070501 | B*0747 | B*0825 |
| B*4404 | B*070502 | B*0748 | B*0826 |
| B*4409 | B*070503 | B*0749N | B*0827 |
| B*0828 | B*1502 | B*1545 | B*1592 |
| B*0829 | B*1503 | B*1546 | B*1593 |
| B*0830N | B*1505 | B*1547 | B*1594N |
| B*0831 | B*1506 | B*1548 | B*1595 |
| B*0832 | B*1507 | B*1549 | B*1596 |
| B*0834 | B*1508 | B*1550 | B*1597 |
| B*0835 | B*1509 | B*1551 | B*1598 |
| B*0836 | B*1510 | B*1552 | B*1599 |
| B*1301 | B*151101 | B*1553 | B*180102 |
| B*130202 | B*151102 | B*1554 | B*180103 |
| B*130204 | B*151103 | B*1555 | B*1802 |
| B*1303 | B*1512 | B*1556 | B*1804 |
| B*1304 | B*1513 | B*1557 | B*1805 |
| B*1306 | B*1514 | B*1558 | B*1806 |
| B*1307N | B*1515 | B*1560 | B*1807 |
| B*1309 | B*1516 | B*1561 | B*1808 |
| B*1310 | B*151702 | B*1562 | B*1809 |
| B*1311 | B*1518 | B*1563 | B*1810 |
| B*1312 | B*1519 | B*1564 | B*1811 |
| B*1313 | B*1520 | B*1565 | B*1812 |
| B*1314 | B*1521 | B*1567 | B*1813 |
| B*1316 | B*1523 | B*1568 | B*1814 |
| B*1317 | B*1524 | B*1569 | B*1815 |
| B*1318 | B*1525 | B*1570 | B*1818 |
| B*1319 | B*1526N | B*1571 | B*1819 |
| B*1320 | B*152701 | B*1572 | B*1820 |
| B*1321 | B*152702 | B*1573 | B*1821 |
| B*1322 | B*152703 | B*1574 | B*1822 |
| B*1401 | B*1528 | B*1575 | B*1823N |
| B*140202 | B*1529 | B*1576 | B*1824 |
| B*1403 | B*1530 | B*1578 | B*1825 |
| B*1404 | B*1531 | B*1579N | B*1827 |
| B*1405 | B*1532 | B*1580 | B*1828 |
| B*140601 | B*1533 | B*1581 | B*1829 |
| B*140602 | B*1534 | B*1582 | B*2701 |
| B*1408 | B*1535 | B*1584 | B*2702 |
| B*1409 | B*1536 | B*1585 | B*2703 |
| B*150102 | B*1537 | B*1586 | B*270401 |
| B*150103 | B*1538 | B*1587 | B*270402 |
| B*150104 | B*1539 | B*1588 | B*270503 |
| B*150106 | B*1540 | B*1589 | B*270504 |
| B*150107 | B*1543 | B*1590 | B*270505 |
| B*150108 | B*1544 | B*1591 | B*270506 |
| B*270507 | B*350106 | B*3536 | B*3580 |
| B*270508 | B*350107 | B*3537 | B*3581 |
| B*270509 | B*350201 | B*3538 | B*3582 |
| B*270510 | B*350202 | B*3539 | B*3583 |
| B*2707 | B*3503 | B*3540N | B*3584 |
| B*2708 | B*350401 | B*3542 | B*3585 |
| B*2709 | B*350402 | B*3543 | B*3586 |
| B*2710 | B*350403 | B*3544 | B*3587 |
| B*2711 | B*3505 | B*3545 | B*3588 |
| B*2712 | B*3506 | B*3546 | B*3590 |
| B*2713 | B*3507 | B*3547 | B*3591 |
| B*2714 | B*350801 | B*3548 | B*3592 |
| B*2715 | B*350802 | B*3549 | B*3593 |
| B*2716 | B*350803 | B*3550 | B*3594 |
| B*2717 | B*350901 | B*3551 | B*370102 |
| B*2718 | B*350902 | B*3552 | B*370103 |
| B*2719 | B*3510 | B*3553N | B*370104 |
| B*2720 | B*3511 | B*3554 | B*3702 |
| B*2721 | B*3512 | B*3555 | B*3703N |
| B*2723 | B*3513 | B*3556 | B*3704 |
| B*2724 | B*351401 | B*3557 | B*3705 |
| B*2725 | B*3515 | B*3558 | B*3706 |
| B*2726 | B*3516 | B*3559 | B*3707 |
| B*2727 | B*3517 | B*3560 | B*3708 |
| B*2728 | B*3518 | B*3561 | B*3709 |
| B*2729 | B*3519 | B*3562 | B*3710 |
| B*2730 | B*352001 | B*3563 | B*3711 |
| B*2731 | B*352002 | B*3564 | B*3712 |
| B*2733 | B*3521 | B*3565Q | B*3713 |
| B*2734 | B*3522 | B*3566 | B*3714 |
| B*2735 | B*3523 | B*3567 | B*380102 |
| B*2736 | B*3524 | B*356801 | B*380202 |
| B*2737 | B*3525 | B*356802 | B*3803 |
| B*2738 | B*3526 | B*3569 | B*3804 |
| B*2739 | B*3527 | B*3570 | B*3805 |
| B*2740 | B*3528 | B*3571 | B*3806 |
| B*2741 | B*3529 | B*3572 | B*3807 |
| B*2742 | B*3530 | B*3574 | B*3808 |
| B*2743 | B*3531 | B*3575 | B*3809 |
| B*350102 | B*3532 | B*3576 | B*3810 |
| B*350103 | B*3533 | B*3577 | B*3811 |
| B*350104 | B*3534 | B*3578 | B*3812 |
| B*350105 | B*3535 | B*3579 | B*3813 |
| B*3815 | B*3940N | B*4032 | B*4076 |
| B*3816 | B*3941 | B*4033 | B*4077 |
| B*3817 | B*3942 | B*4034 | B*4078 |
| B*390104 | B*3943 | B*4035 | B*4080 |
| B*390105 | B*3944 | B*4036 | B*4081 |
| B*390201 | B*3945 | B*4037 | B*4082 |
| B*390202 | B*400101 | B*4038 | B*4083 |
| B*3903 | B*400103 | B*4039 | B*4084 |
| B*3904 | B*400104 | B*4040 | B*4085 |
| B*3905 | B*400105 | B*4042 | B*4086 |
| B*390601 | B*400106 | B*4043 | B*4087 |
| B*390602 | B*400202 | B*4044 | B*4088 |
| B*3907 | B*400203 | B*4045 | B*4089 |
| B*3908 | B*4003 | B*4046 | B*4090 |
| B*3909 | B*4004 | B*4047 | B*4091 |
| B*3911 | B*4005 | B*4048 | B*4092 |
| B*3912 | B*400602 | B*4049 | B*4102 |
| B*391301 | B*4007 | B*4050 | B*410301 |
| B*3914 | B*4008 | B*4051 | B*410302 |
| B*3915 | B*4009 | B*4052 | B*4104 |
| B*3916 | B*4010 | B*4053 | B*4105 |
| B*3917 | B*4011 | B*4054 | B*4106 |
| B*3918 | B*4012 | B*4055 | B*4107 |
| B*391901 | B*4013 | B*4056 | B*4108 |
| B*391902 | B*401401 | B*4057 | B*4202 |
| B*3920 | B*401402 | B*4058 | B*4204 |
| B*3922 | B*401403 | B*4059 | B*420501 |
| B*3923 | B*4015 | B*4060 | B*420502 |
| B*3924 | B*4016 | B*4061 | B*4206 |
| B*3925N | B*4018 | B*4062 | B*4207 |
| B*3926 | B*4019 | B*4063 | B*4209 |
| B*3927 | B*4020 | B*4064 | B*440202 |
| B*3928 | B*4021 | B*4065 | B*440203 |
| B*3929 | B*4022N | B*4066 | B*440204 |
| B*3930 | B*4023 | B*4067 | B*440205 |
| B*3931 | B*4024 | B*4068 | B*440301 |
| B*3932 | B*4025 | B*4069 | B*440302 |
| B*3933 | B*4026 | B*4070 | B*440303 |
| B*3935 | B*4027 | B*4071 | B*4405 |
| B*3936 | B*4028 | B*407202 | B*4406 |
| B*3937 | B*4029 | B*4073 | B*4407 |
| B*3938Q | B*4030 | B*4074 | B*4408 |
| B*3939 | B*4031 | B*4075 | B*4410 |
| B*4411 | B*4457 | B*4807 | B*5116 |
| B*4412 | B*4458N | B*4809 | B*5117 |
| B*4413 | B*4459 | B*4810 | B*5118 |
| B*4414 | B*4460 | B*4811 | B*5119 |
| B*4415 | B*4461N | B*4812 | B*5120 |
| B*4416 | B*4462 | B*4813 | B*5121 |
| B*4417 | B*4463 | B*4814 | B*5122 |
| B*4418 | B*446401 | B*4815 | B*5123 |
| B*4419N | B*446402 | B*4816 | B*512401 |
| B*4420 | B*4502 | B*4817 | B*512402 |
| B*4421 | B*4503 | B*4818 | B*5126 |
| B*4422 | B*4505 | B*4819 | B*5127N |
| B*4424 | B*4506 | B*4902 | B*5128 |
| B*4425 | B*4507 | B*4903 | B*5129 |
| B*4426 | B*4508 | B*4904 | B*5130 |
| B*4427 | B*4509 | B*4905 | B*5131 |
| B*442801 | B*460102 | B*5002 | B*5132 |
| B*442802 | B*4602 | B*5004 | B*5133 |
| B*4429 | B*4603 | B*510103 | B*5134 |
| B*4430 | B*4604 | B*510104 | B*5135 |
| B*4431 | B*4605 | B*510105 | B*5136 |
| B*4432 | B*4606 | B*510106 | B*5137 |
| B*4433 | B*4607N | B*510107 | B*5138 |
| B*4434 | B*4608 | B*510108 | B*5139 |
| B*4435 | B*4609 | B*510109 | B*5140 |
| B*4436 | B*4610 | B*510201 | B*5141N |
| B*4437 | B*4611 | B*510202 | B*5143 |
| B*4438 | B*4612 | B*510203 | B*5144N |
| B*4439 | B*4613 | B*5103 | B*5145 |
| B*4440 | B*4614 | B*5104 | B*5146 |
| B*4441 | B*4615N | B*5105 | B*5148 |
| B*4442 | B*4616 | B*5106 | B*5149 |
| B*4443 | B*4702 | B*5107 | B*5150 |
| B*4444 | B*4703 | B*5108 | B*5151 |
| B*4445 | B*4704 | B*510901 | B*5152 |
| B*4447 | B*4705 | B*510902 | B*5153 |
| B*4448 | B*480102 | B*5110 | B*5154 |
| B*4450 | B*4802 | B*5111N | B*5155 |
| B*4451 | B*480301 | B*5112 | B*5156 |
| B*4452N | B*480302 | B*511301 | B*5157 |
| B*4453 | B*4804 | B*511302 | B*520102 |
| B*4454 | B*4805 | B*5114 | B*520103 |
| B*4455 | B*4806 | B*5115 | B*520104 |
| B*5202 | B*5413 | B*5609 | B*5813 |
| B*5203 | B*5414 | B*5610 | B*5814 |
| B*5204 | B*5415 | B*5611 | B*5815 |
| B*5205 | B*550102 | B*5612 | B*5816 |
| B*520601 | B*550104 | B*5613 | B*5817N |
| B*520602 | B*550201 | B*5614 | B*5818 |
| B*5207 | B*550202 | B*5615 | B*5819 |
| B*5208 | B*5503 | B*5616 | B*5901 |
| B*5209 | B*5504 | B*5617 | B*5902 |
| B*5210 | B*5505 | B*5618 | B*5903 |
| B*5211 | B*5507 | B*5619N | B*670101 |
| B*5212 | B*5508 | B*5620 | B*670102 |
| B*5213 | B*5509 | B*5621 | B*780201 |
| B*5214 | B*5510 | B*5622 | B*780202 |
| B*530102 | B*5511 | B*5623 | B*7803 |
| B*530103 | B*5513 | B*570102 | B*7804 |
| B*530104 | B*5514 | B*570103 | B*7805 |
| B*5302 | B*5515 | B*5702 | B*7806 |
| B*5303 | B*5516 | B*570301 | B*8101 |
| B*5304 | B*5517 | B*570302 | B*8102 |
| B*5305 | B*5518 | B*5704 | B*8103 |
| B*5306 | B*5519 | B*5705 | B*8104N |
| B*5307 | B*5520 | B*5707 | B*8201 |
| B*5308 | B*5521 | B*5708 | B*8301 |
| B*5309 | B*5522 | B*5709 | B*9501 |
| B*5310 | B*5523 | B*5710 | B*9502 |
| B*5312 | B*5525 | B*5712 | B*9503 |
| B*5313 | B*5526 | B*5713 | B*9504 |
| B*5314 | B*5527 | B*5714 | B*9505 |
| B*5315 | B*5528 | B*5715 | B*9506 |
| B*5316 | B*5529 | B*5716 | B*9507 |
| B*5401 | B*5530 | B*5717 | B*9509 |
| B*5402 | B*5531 | B*580102 | B*9510 |
| B*5403 | B*5532 | B*5802 | B*9511N |
| B*5404 | B*5601 | B*5804 | B*9512 |
| B*5405N | B*5602 | B*5805 | B*9513 |
| B*5406 | B*5603 | B*5806 | B*9514 |
| B*5407 | B*5604 | B*5807 | B*9515 |
| B*5408N | B*560501 | B*5808 | B*9516 |
| B*5409 | B*560502 | B*5809 | B*9517 |
| B*5410 | B*5606 | B*5810N | B*9518 |
| B*5411 | B*5607 | B*5811 | B*9519 |
| B*5412 | B*5608 | B*5812 | B*9520 |
| B*9521 | Cw*06020101 | Cw*0116 | Cw*0307 |
| B*9522 | Cw*06020102 | Cw*0117 | Cw*0308 |
| B*9523 | Cw*070101 | Cw*0118 | Cw*0309 |
| B*9524 | Cw*07020101 | Cw*0119 | Cw*0310 |
| B*9525 | Cw*07020102 | Cw*0120 | Cw*031101 |
| B*9526 | Cw*07020103 | Cw*0121 | Cw*031102 |
| B*9527 | Cw*070401 | Cw*0122 | Cw*0312 |
| B*9528 | Cw*070402 | Cw*020201 | Cw*0314 |
| B*9529 | Cw*0719 | Cw*020203 | Cw*0315 |
| B*9531 | Cw*0726 | Cw*020205 | Cw*0316 |
| B*9532 | Cw*0730 | Cw*020206 | Cw*0317 |
| B*9533 | Cw*0732N | Cw*0203 | Cw*0318 |
| B*9534 | Cw*0749 | Cw*0204 | Cw*0319 |
| B*9535 | Cw*080101 | Cw*0205 | Cw*0321 |
| B*9536 | Cw*0802 | Cw*0206 | Cw*0322Q |
| B*9537 | Cw*120202 | Cw*0207 | Cw*0323 |
| B*9538 | Cw*12030101 | Cw*0208 | Cw*0324 |
| B*9539 | Cw*12030102 | Cw*0209 | Cw*0325 |
| B*9540 | Cw*1208 | Cw*0210 | Cw*0326 |
| B*9541 | Cw*1213 | Cw*0212 | Cw*0327 |
| B*9542 | Cw*1219 | Cw*0213 | Cw*0328 |
| B*9543 | Cw*1403 | Cw*0214 | Cw*0329 |
| B*9544 | Cw*150201 | Cw*0215 | Cw*0330 |
| B*9545 | Cw*1516 | Cw*0216 | Cw*0331 |
| B*9546 | Cw*160101 | Cw*0217 | Cw*0332 |
| B*9547 | Cw*1701 | Cw*0218 | Cw*0333 |
| B*9548 | Cw*1801 | Cw*0219 | Cw*0334 |
| B*9549N | Cw*010202 | Cw*0220 | Cw*0335 |
| Cw*010201 | Cw*010203 | Cw*0221 | Cw*0336 |
| Cw*0114 | Cw*010204 | Cw*0222 | Cw*0337 |
| Cw*020202 | Cw*010205 | Cw*030201 | Cw*033801 |
| Cw*0211 | Cw*0103 | Cw*030203 | Cw*033802 |
| Cw*030202 | Cw*0104 | Cw*030301 | Cw*0339 |
| Cw*030401 | Cw*0105 | Cw*030302 | Cw*0340 |
| Cw*030402 | Cw*0106 | Cw*030303 | Cw*0341 |
| Cw*0306 | Cw*0107 | Cw*030304 | Cw*0342 |
| Cw*0313 | Cw*0108 | Cw*030305 | Cw*0343 |
| Cw*0320N | Cw*0109 | Cw*030403 | Cw*0344 |
| Cw*04010101 | Cw*0110 | Cw*030404 | Cw*0345 |
| Cw*04010102 | Cw*0111 | Cw*030405 | Cw*0346 |
| Cw*050101 | Cw*0112 | Cw*030406 | Cw*0347 |
| Cw*0508 | Cw*0113 | Cw*030407 | Cw*0348 |
| Cw*0509 | Cw*0115 | Cw*0305 | Cw*0349 |
| Cw*0350 | Cw*0506 | Cw*0710 | Cw*080102 |
| Cw*040102 | Cw*0507N | Cw*0711 | Cw*0803 |
| Cw*040103 | Cw*0510 | Cw*0712 | Cw*0804 |
| Cw*040104 | Cw*0511 | Cw*0713 | Cw*0805 |
| Cw*040105 | Cw*0512 | Cw*0714 | Cw*0806 |
| Cw*0403 | Cw*0513 | Cw*0715 | Cw*0807 |
| Cw*040401 | Cw*0514 | Cw*0716 | Cw*0808 |
| Cw*040402 | Cw*0515 | Cw*0717 | Cw*0809 |
| Cw*0405 | Cw*0516 | Cw*0718 | Cw*0810 |
| Cw*0406 | Cw*0517 | Cw*0720 | Cw*0811 |
| Cw*0407 | Cw*0518 | Cw*0721 | Cw*0812 |
| Cw*0408 | Cw*0519 | Cw*0722 | Cw*0813 |
| Cw*0409N | Cw*060203 | Cw*0723 | Cw*0814 |
| Cw*0410 | Cw*0603 | Cw*0724 | Cw*0815 |
| Cw*0411 | Cw*0604 | Cw*0725 | Cw*0816 |
| Cw*0412 | Cw*0605 | Cw*072701 | Cw*120201 |
| Cw*0413 | Cw*0606 | Cw*072702 | Cw*120203 |
| Cw*0414 | Cw*0607 | Cw*0728 | Cw*120302 |
| Cw*041501 | Cw*0608 | Cw*0729 | Cw*120303 |
| Cw*041502 | Cw*0609 | Cw*0731 | Cw*120304 |
| Cw*0416 | Cw*0610 | Cw*0733N | Cw*120305 |
| Cw*0417 | Cw*0611 | Cw*0735 | Cw*120306 |
| Cw*0418 | Cw*0612 | Cw*0736 | Cw*120401 |
| Cw*0419 | Cw*0613 | Cw*0737 | Cw*120402 |
| Cw*0420 | Cw*0614 | Cw*0738 | Cw*1205 |
| Cw*0423 | Cw*0615 | Cw*0739 | Cw*1206 |
| Cw*0424 | Cw*0616N | Cw*0740 | Cw*1207 |
| Cw*0425 | Cw*0617 | Cw*0741 | Cw*1209 |
| Cw*0426 | Cw*070102 | Cw*0742 | Cw*1210 |
| Cw*0427 | Cw*070103 | Cw*0743 | Cw*1211 |
| Cw*0428 | Cw*070104 | Cw*0744 | Cw*1212 |
| Cw*0429 | Cw*070105 | Cw*0745 | Cw*1214 |
| Cw*0430 | Cw*070106 | Cw*0746 | Cw*1215 |
| Cw*0431 | Cw*070107 | Cw*0747 | Cw*1216 |
| Cw*0432 | Cw*070108 | Cw*0748 | Cw*1217 |
| Cw*0433 | Cw*070109 | Cw*0750 | Cw*1218 |
| Cw*0434 | Cw*070202 | Cw*0751 | Cw*1220 |
| Cw*050102 | Cw*0703 | Cw*0752 | Cw*1221 |
| Cw*050103 | Cw*0705 | Cw*0753 | Cw*140201 |
| Cw*050104 | Cw*0706 | Cw*0754 | Cw*140202 |
| Cw*0503 | Cw*0707 | Cw*0755N | Cw*140203 |
| Cw*0504 | Cw*0708 | Cw*0756 | Cw*140204 |
| Cw*0505 | Cw*0709 | Cw*0757 | Cw*1404 |
| Cw*1405 | Cw*1802 | DRB1*0306 | DRB1*0404 |
| Cw*1406 | Cw*1803 | DRB1*0307 | DRB1*040501 |
| Cw*1407N | DRB1*010101 | DRB1*0308 | DRB1*040502 |
| Cw*1408 | DRB1*010102 | DRB1*0309 | DRB1*040503 |
| Cw*1409 | DRB1*010103 | DRB1*0310 | DRB1*040504 |
| Cw*150202 | DRB1*010104 | DRB1*0311 | DRB1*040505 |
| Cw*150203 | DRB1*010105 | DRB1*0312 | DRB1*040506 |
| Cw*150204 | DRB1*010106 | DRB1*0313 | DRB1*040601 |
| Cw*1503 | DRB1*010107 | DRB1*0314 | DRB1*040602 |
| Cw*1504 | DRB1*010201 | DRB1*0315 | DRB1*040701 |
| Cw*150501 | DRB1*010202 | DRB1*0316 | DRB1*040702 |
| Cw*150502 | DRB1*010203 | DRB1*0317 | DRB1*040703 |
| Cw*150503 | DRB1*010204 | DRB1*0318 | DRB1*0408 |
| Cw*150504 | DRB1*0103 | DRB1*0319 | DRB1*0409 |
| Cw*1506 | DRB1*0104 | DRB1*0320 | DRB1*0410 |
| Cw*1507 | DRB1*0105 | DRB1*0321 | DRB1*0411 |
| Cw*1508 | DRB1*0106 | DRB1*0322 | DRB1*0412 |
| Cw*1509 | DRB1*0107 | DRB1*0323 | DRB1*0413 |
| Cw*151001 | DRB1*0108 | DRB1*0324 | DRB1*0414 |
| Cw*151002 | DRB1*0109 | DRB1*0325 | DRB1*0415 |
| Cw*1511 | DRB1*0110 | DRB1*0326 | DRB1*0416 |
| Cw*1512 | DRB1*0111 | DRB1*0327 | DRB1*0417 |
| Cw*1513 | DRB1*0112 | DRB1*0328 | DRB1*0418 |
| Cw*1515 | DRB1*0113 | DRB1*0329 | DRB1*0419 |
| Cw*1517 | DRB1*0114 | DRB1*0330 | DRB1*0420 |
| Cw*1518 | DRB1*0115 | DRB1*0331 | DRB1*0421 |
| Cw*1519 | DRB1*0116 | DRB1*0332 | DRB1*0422 |
| Cw*1520 | DRB1*0117 | DRB1*0333 | DRB1*0423 |
| Cw*1521 | DRB1*0118 | DRB1*0334 | DRB1*0424 |
| Cw*160102 | DRB1*0119 | DRB1*0335 | DRB1*0425 |
| Cw*160103 | DRB1*0120 | DRB1*0336 | DRB1*0426 |
| Cw*1602 | DRB1*030101 | DRB1*0337 | DRB1*0427 |
| Cw*160401 | DRB1*030102 | DRB1*0338 | DRB1*0428 |
| Cw*1606 | DRB1*030103 | DRB1*0339 | DRB1*0429 |
| Cw*1607 | DRB1*030104 | DRB1*0340 | DRB1*0430 |
| Cw*1608 | DRB1*030105 | DRB1*040101 | DRB1*0431 |
| Cw*1609 | DRB1*030106 | DRB1*040102 | DRB1*0432 |
| Cw*1610 | DRB1*030201 | DRB1*040103 | DRB1*0433 |
| Cw*1611 | DRB1*030202 | DRB1*0402 | DRB1*0434 |
| Cw*1702 | DRB1*0303 | DRB1*040301 | DRB1*0435 |
| Cw*1703 | DRB1*0304 | DRB1*040302 | DRB1*0436 |
| Cw*1704 | DRB1*030501 | DRB1*040303 | DRB1*0437 |
| Cw1801 | DRB1*030502 | DRB1*040304 | DRB1*0438 |
| DRB1*0439 | DRB1*0705 | DRB1*0826 | DRB1*1109 |
| DRB1*0440 | DRB1*0706 | DRB1*0827 | DRB1*1110 |
| DRB1*0441 | DRB1*0707 | DRB1*0828 | DRB1*111101 |
| DRB1*0442 | DRB1*0708 | DRB1*0829 | DRB1*111102 |
| DRB1*0443 | DRB1*0709 | DRB1*0830 | DRB1*111201 |
| DRB1*0444 | DRB1*0710N | DRB1*0831 | DRB1*111202 |
| DRB1*0445 | DRB1*0711 | DRB1*0832 | DRB1*1113 |
| DRB1*0446 | DRB1*0712 | DRB1*0833 | DRB1*111401 |
| DRB1*0447 | DRB1*0713 | DRB1*0834 | DRB1*111402 |
| DRB1*0448 | DRB1*0714 | DRB1*0835 | DRB1*1115 |
| DRB1*0449 | DRB1*0715 | DRB1*090102 | DRB1*1116 |
| DRB1*0450 | DRB1*080101 | DRB1*090103 | DRB1*1117 |
| DRB1*0451 | DRB1*080102 | DRB1*090104 | DRB1*1118 |
| DRB1*0452 | DRB1*080103 | DRB1*0902 | DRB1*111901 |
| DRB1*0453 | DRB1*080201 | DRB1*0903 | DRB1*111902 |
| DRB1*0454 | DRB1*080202 | DRB1*0904 | DRB1*1120 |
| DRB1*0455 | DRB1*080203 | DRB1*0905 | DRB1*1121 |
| DRB1*0456 | DRB1*080302 | DRB1*0906 | DRB1*1122 |
| DRB1*0457 | DRB1*080401 | DRB1*0907 | DRB1*1123 |
| DRB1*0458 | DRB1*080402 | DRB1*100101 | DRB1*1124 |
| DRB1*0459 | DRB1*080403 | DRB1*100102 | DRB1*1125 |
| DRB1*0460 | DRB1*080404 | DRB1*1002 | DRB1*1126 |
| DRB1*0461 | DRB1*0805 | DRB1*1003 | DRB1*112701 |
| DRB1*0462 | DRB1*0806 | DRB1*110101 | DRB1*112702 |
| DRB1*0463 | DRB1*0807 | DRB1*110102 | DRB1*1128 |
| DRB1*0464 | DRB1*0808 | DRB1*110103 | DRB1*1129 |
| DRB1*0465 | DRB1*0809 | DRB1*110104 | DRB1*1130 |
| DRB1*0466 | DRB1*0810 | DRB1*110105 | DRB1*1131 |
| DRB1*0467 | DRB1*0811 | DRB1*110106 | DRB1*1132 |
| DRB1*0468 | DRB1*0812 | DRB1*110107 | DRB1*1133 |
| DRB1*0469 | DRB1*0813 | DRB1*110201 | DRB1*1134 |
| DRB1*0470 | DRB1*0814 | DRB1*110202 | DRB1*1135 |
| DRB1*0471 | DRB1*0815 | DRB1*1103 | DRB1*1136 |
| DRB1*0472 | DRB1*0816 | DRB1*110401 | DRB1*1137 |
| DRB1*0473 | DRB1*0817 | DRB1*110402 | DRB1*1138 |
| DRB1*0474 | DRB1*0818 | DRB1*110403 | DRB1*1139 |
| DRB1*0475 | DRB1*0819 | DRB1*110404 | DRB1*1140 |
| DRB1*0476 | DRB1*0820 | DRB1*1105 | DRB1*1141 |
| DRB1*0477 | DRB1*0821 | DRB1*110601 | DRB1*1142 |
| DRB1*070101 | DRB1*0822 | DRB1*110602 | DRB1*1143 |
| DRB1*070102 | DRB1*0823 | DRB1*1107 | DRB1*1144 |
| DRB1*0703 | DRB1*0824 | DRB1*110801 | DRB1*1145 |
| DRB1*0704 | DRB1*0825 | DRB1*110802 | DRB1*1146 |
| DRB1*1147 | DRB1*1216 | DRB1*1333 | DRB1*1375 |
| DRB1*1148 | DRB1*130101 | DRB1*1334 | DRB1*1376 |
| DRB1*1149 | DRB1*130102 | DRB1*1335 | DRB1*1377 |
| DRB1*1150 | DRB1*130103 | DRB1*1336 | DRB1*1378 |
| DRB1*1151 | DRB1*130201 | DRB1*1337 | DRB1*1379 |
| DRB1*1152 | DRB1*130202 | DRB1*1338 | DRB1*1380 |
| DRB1*1153 | DRB1*130203 | DRB1*1339 | DRB1*1381 |
| DRB1*115401 | DRB1*130301 | DRB1*1340 | DRB1*1382 |
| DRB1*115402 | DRB1*130302 | DRB1*1341 | DRB1*1383 |
| DRB1*1155 | DRB1*1304 | DRB1*1342 | DRB1*1384 |
| DRB1*1156 | DRB1*130501 | DRB1*1343 | DRB1*1385 |
| DRB1*1157 | DRB1*130502 | DRB1*1344 | DRB1*1386 |
| DRB1*1158 | DRB1*1306 | DRB1*1345 | DRB1*140101 |
| DRB1*1159 | DRB1*130701 | DRB1*1346 | DRB1*140102 |
| DRB1*1160 | DRB1*130702 | DRB1*1347 | DRB1*140103 |
| DRB1*1161 | DRB1*1308 | DRB1*1348 | DRB1*1402 |
| DRB1*1162 | DRB1*1309 | DRB1*1349 | DRB1*140301 |
| DRB1*1163 | DRB1*1310 | DRB1*135001 | DRB1*140302 |
| DRB1*1164 | DRB1*131101 | DRB1*135002 | DRB1*1404 |
| DRB1*116501 | DRB1*131102 | DRB1*1351 | DRB1*140501 |
| DRB1*116502 | DRB1*1312 | DRB1*1352 | DRB1*140502 |
| DRB1*1166 | DRB1*1313 | DRB1*1353 | DRB1*140503 |
| DRB1*1167 | DRB1*131401 | DRB1*1354 | DRB1*1406 |
| DRB1*1168 | DRB1*131402 | DRB1*1355 | DRB1*140701 |
| DRB1*1169 | DRB1*131403 | DRB1*1356 | DRB1*140702 |
| DRB1*120101 | DRB1*1315 | DRB1*1357 | DRB1*1408 |
| DRB1*120102 | DRB1*1316 | DRB1*1358 | DRB1*1409 |
| DRB1*120201 | DRB1*1317 | DRB1*1359 | DRB1*1410 |
| DRB1*120202 | DRB1*1318 | DRB1*1360 | DRB1*1411 |
| DRB1*120203 | DRB1*1319 | DRB1*1361 | DRB1*1412 |
| DRB1*120302 | DRB1*1320 | DRB1*1362 | DRB1*1413 |
| DRB1*1204 | DRB1*1321 | DRB1*1363 | DRB1*1414 |
| DRB1*1205 | DRB1*1322 | DRB1*1364 | DRB1*1415 |
| DRB1*1206 | DRB1*1323 | DRB1*1365 | DRB1*1416 |
| DRB1*1207 | DRB1*1324 | DRB1*1366 | DRB1*1417 |
| DRB1*1208 | DRB1*1325 | DRB1*1367 | DRB1*1418 |
| DRB1*1209 | DRB1*1326 | DRB1*1368 | DRB1*1419 |
| DRB1*1210 | DRB1*1327 | DRB1*1369 | DRB1*1420 |
| DRB1*1211 | DRB1*1328 | DRB1*1370 | DRB1*1421 |
| DRB1*1212 | DRB1*1329 | DRB1*1371 | DRB1*1422 |
| DRB1*1213 | DRB1*1330 | DRB1*1372 | DRB1*142301 |
| DRB1*1214 | DRB1*1331 | DRB1*1373 | DRB1*142302 |
| DRB1*1215 | DRB1*1332 | DRB1*1374 | DRB1*1424 |
| DRB1*1425 | DRB1*1465 | DRB1*1517N | |
| DRB1*1426 | DRB1*1467 | DRB1*1518 | |
| DRB1*1427 | DRB1*1468 | DRB1*1519 | |
| DRB1*1428 | DRB1*1469 | DRB1*1520 | |
| DRB1*1429 | DRB1*1470 | DRB1*1521 | |
| DRB1*1430 | DRB1*1471 | DRB1*1522 | |
| DRB1*1431 | DRB1*1472 | DRB1*1523 | |
| DRB1*143201 | DRB1*1473 | DRB1*1524 | |
| DRB1*143202 | DRB1*1474 | DRB1*1525 | |
| DRB1*1433 | DRB1*1475 | DRB1*1526 | |
| DRB1*1434 | DRB1*1476 | DRB1*1527 | |
| DRB1*1435 | DRB1*1477 | DRB1*1528 | |
| DRB1*1436 | DRB1*1478 | DRB1*1529 | |
| DRB1*1437 | DRB1*1479 | DRB1*1530 | |
| DRB1*1438 | DRB1*1480 | DRB1*1531 | |
| DRB1*1439 | DRB1*1481 | DRB1*160101 | |
| DRB1*1440 | DRB1*150101 | DRB1*160102 | |
| DRB1*1441 | DRB1*150102 | DRB1*160201 | |
| DRB1*1442 | DRB1*150103 | DRB1*160202 | |
| DRB1*1443 | DRB1*150104 | DRB1*1603 | |
| DRB1*144401 | DRB1*150105 | DRB1*1604 | |
| DRB1*144402 | DRB1*150106 | DRB1*160501 | |
| DRB1*1445 | DRB1*150201 | DRB1*160502 | |
| DRB1*1446 | DRB1*150202 | DRB1*1607 | |
| DRB1*1447 | DRB1*150203 | DRB1*1608 | |
| DRB1*1448 | DRB1*150204 | DRB1*1609 | |
| DRB1*1449 | DRB1*150205 | DRB1*1610 | |
| DRB1*1450 | DRB1*150206 | DRB1*1611 | |
| DRB1*1451 | DRB1*1503 | DRB1*1612 | |
| DRB1*1452 | DRB1*1504 | DRB1*1613 | |
| DRB1*1453 | DRB1*1505 | | |
| DRB1*1454 | DRB1*1506 | | |
| DRB1*1455 | DRB1*1507 | | |
| DRB1*1456 | DRB1*1508 | | |
| DRB1*1457 | DRB1*1509 | | |
| DRB1*1458 | DRB1*1510 | | |
| DRB1*1459 | DRB1*1511 | | |
| DRB1*1460 | DRB1*1512 | | |
| DRB1*1461 | DRB1*1513 | | |
| DRB1*1462 | DRB1*1514 | | |
| DRB1*1463 | DRB1*1515 | | |
| DRB1*1464 | DRB1*1516 | | |

We claim:

1. A method of constructing a compatibility profile for an individual, comprising:
a) providing a data set for the individual, the data set comprising alleles corresponding to four or more human leukocyte antigen (HLA) loci; and
b) providing a computer programmed with a comparison software application to assign an encoded reference to each allele in the data set.

2. The method of claim 1, wherein the data set further comprises alleles corresponding to the AVPR1A locus.

3. A method of evaluating the compatibility of a first individual and a second individual, comprising:
a) providing a first data set for a first individual and a second data set for a second individual, each of the first and second data sets comprising alleles for at least four human leukocyte antigen (HLA) loci;
b) calculating a number of similar HLA alleles between an alignment of the first and second data sets;
c) assigning a compatibility score corresponding to the number of similar HLA alleles between the first individual and the second individual; and
d) displaying the compatibility score and/or a compatibility recommendation on a computer user interface.

4. The method of claim 3, further comprising assigning an encoded reference to each allele in the data set.

5. The method of claim 3 further comprising reporting to the first individual a compatibility recommendation corresponding to the compatibility score.

6. The method of claim 5 wherein a compatibility score of 0 results in a compatibility recommendation of optimal for sexual satisfaction and/or adequate for long term relationship potential.

7. The method of claim 5 wherein a compatibility score of 1 results in a compatibility recommendation of reasonable for sexual satisfaction and/or reasonable for long term relationship potential.

8. The method of claim 5 wherein a compatibility score of 2 or 3 results in a compatibility recommendation of adequate for sexual satisfaction and/or optimal for long term relationship potential.

9. The method of claim 5 wherein a compatibility score of 4 or more results in a compatibility recommendation of poor for sexual satisfaction and/or undetermined for long term relationship potential.

10. The method of claim 3, wherein the first and second data sets further comprise alleles corresponding to the AVPR1A locus.

11. The method of claim 10, wherein the presence of two alleles corresponding to a high-risk AVPR1A locus correlates with a high risk for non-monogamous behavior and decreased likelihood of marriage, the presence of one allele corresponding to a high-risk AVPR1A locus correlates with a moderate risk for non-monogamous behavior and decreased likelihood of marriage, and the presence of no copies of an allele corresponding to a high-risk AVPR1A locus correlates with a low risk for non-monogamous behavior and reasonable or average likelihood of marriage.

12. The method of claim 3 wherein the data set comprises the alleles identified through an analysis of at least 493 single nucleotide polymorphisms (SNPs).

13. A method of operating a dating service, comprising:
a) providing a computer programmed with a comparison software application to calculate a compatibility score of a first individual and a second individual according to the method of claim 3; and
b) communicating a compatibility recommendation based on the compatibility score.

14. The method of claim 13 wherein the dating service is offered through a website.

15. The method of claim 13 wherein the dating service is offered as a widget on a website.

16. The method of claim 13 further comprising calculating a compatibility score of the first individual and each member of a group of second individuals.

17. The method of claim 16 wherein the group of second individuals comprises friends.

18. The method of claim 16 wherein the group of second individuals comprises clients.

19. The method of claim 16 wherein the group of second individuals comprises subscribers.

20. A method of conducting business, comprising:
a) providing a collection kit to a customer;
b) receiving the collection kit and a sample from the customer;
c) evaluating the sample for the presence of at least one single nucleotide polymorphism (SNP) associated with at least one human leukocyte antigen (HLA) allele;
d) assigning an encoded reference to the at least one HLA allele to construct a compatibility profile;
e) communicating the compatibility profile to the customer in a computer-readable format adapted for display on a website user interface; and
f) comparing the compatibility profile of the customer to a compatibility profile of a second customer and communicating a compatibility recommendation to at least the customer.

21. The method of claim 20 wherein the customer initiates the comparison of step (f).

22. The method of claim 20, further comprising evaluating the sample for the presence of at least one AVPR1A allele and assigning an encoded reference to the AVPR1A allele to construct the compatibility profile.

23. A system for comparing compatibility profiles of at least two individuals.

24. The system of claim 23, wherein the system comprises a comparison software application programmed on a computer or accessed on a website user interface.
